(19) United States
(12) Patent Application Publication
(10) Pub. No.: US 2008/0115101 A1
(43) Pub. Date: May 15, 2008

(54) Program conversion apparatus

(76) Inventor: Yuichiro Ishikawa, Osaka (JP)

Correspondence Address: MCDERMOTT WILL & EMERY LLP, 600 13TH STREET, NW, WASHINGTON, DC, 20005-3096, US

(21) Appl. No.: 11/889,571

(22) Filed: Aug. 14, 2007

(30) Foreign Application Priority Data
Nov. 9, 2006 (JP) 2006-304196

(51) Int. Cl. G06F 17/50

(52) U.S. Cl. 716/18

(57) ABSTRACT

Provided is a program conversion apparatus for converting a type of program into another type of program in which a circuit, which has a spec that a user wants, is described. The program conversion apparatus converts the type of program into the another type of program based on a description of the type of program. The program conversion apparatus (i) converts an operation description program, in which a sequence of operations are described, into a circuit description program, in which a design of a circuit that realizes the sequence of operations is described, (ii) outputs the circuit description program, (iii) generates an indicator that shows a spec of the circuit that is realized by using one or more hardware elements in accordance with the design described in the circuit description program, and (iv) outputs the generated indicator.

This application is based on an application No. 2006-304196 filed in Japan, the content of which is hereby incorporated by reference.

### BACKGROUND OF THE INVENTION

(1) Field of the Invention

The present invention relates to technology for converting a type of program into another type of program. Especially, the present invention relates to technology for, in the course of designing a circuit, converting a type of program, in which operations of the circuit to be designed are described, into another type of program that carries out the operations and describes a circuit having a spec a user wants.

(2) Description of the Related Art

The recent development of software has produced a program conversion apparatus that converts a type of program into another type of program. One example of the program conversion apparatus is a compiler that converts a program written in a high-level language into a machine language. The program conversion apparatus is described in Patent Document 1.

LSI designers have conventionally designed system LSIs, which are becoming larger in scale, by using a hardware description language (e.g., VHDL and Verilog HDL). However, recent years have witnessed the emergence of high-level synthesis technology, with which the system LSI is designed by first designing the processing of hardware with use of the high-level language which is considerably abstract, and then automatically converting the high-level language into the hardware description language. This technology utilizes a high-level synthesis apparatus that converts the considerably abstract high-level language into the hardware description language.

The following is a detailed description of the high-level synthesis apparatus. The high-level synthesis apparatus receives, as an input, a behavior description written in the high-level language such as the C programming language, and outputs an RTL (Register Transfer Level) description of hardware that executes the processing expressed by the inputted behavior description. The RTL description, for example, is a text-based description of configuration information of hardware (e.g., an electric circuit). As such, the high-level synthesis apparatus is a program conversion apparatus that converts the behavior description into the RTL description of the hardware. The high-level synthesis apparatus is described in Patent Document 2.

Hereinafter, a pre-conversion program is referred to as an input program, whereas a post-conversion program is referred to as an object program.

Patent Document 2 discloses technology for preventing the generation of a loop in the circuit.

When a conventional high-level synthesis apparatus is used to convert the input program into the object program, users (circuit designers) of the high-level synthesis apparatus want different specs for the circuit which is described by the object program. For example, the circuit designers may want the following specs: the hardware to be generated has a minimal area; and the hardware has a minimal execution time.

With the technology disclosed by Patent Document 2, it is possible to acquire hardware (a circuit) with a spec that can prevent the generation of the loop. However, in a case where a designer wants the object circuit to have another different spec, the technology of Patent Document 2 does not necessarily provide the designer with the hardware (circuit) having the spec he/she wants.

In light of the above problem, the present invention aims to provide a program conversion apparatus, a program conversion method, a computer program, and a recording medium that can convert a program into another program that describes a circuit having a spec a designer wants.

[Patent Document 1]

Japanese Laid-Open Patent Application No. 2005-174045

[Patent Document 2]

Japanese Laid-Open Patent Application No. 2006-127346

### SUMMARY OF THE INVENTION

In order to achieve the above aim, the present invention is a program conversion apparatus for converting a type of program into another type of program based on a description of the type of program, the program conversion apparatus comprising: a conversion unit operable to convert an operation description program, in which a sequence of operations are described, into a circuit description program, in which a design of a circuit that realizes the sequence of operations is described; a program output unit operable to output the circuit description program; a generation unit operable to generate an indicator that shows a spec of the circuit that is realized by using one or more hardware elements in accordance with the design described in the circuit description program; and an indicator output unit operable to output the generated indicator.

In the above structure, the program conversion apparatus outputs the indicator for the circuit that is realized in accordance with the design described in the circuit description program. Accordingly, with reference to the outputted indicator, a user of the apparatus can judge whether or not the circuit, which is realized in accordance with the design described in the circuit description program, has a spec he/she wants. If judging the spec is not satisfied, the user can easily develop a better program conversion plan. By repeating operations of (i) inputting the operation description program and (ii) easily developing the better program conversion plan with reference to the outputted indicator, the user can acquire a circuit description program in which a design, which shows the circuit having the spec he/she wants, is described.

The program conversion apparatus may further include a plan reception unit operable to receive, before the conversion unit performs the conversion, a plan showing a spec that a user wants for the circuit that realizes the sequence of operations, wherein the conversion unit converts the operation description program into the circuit description program based on the plan.

With this structure, the program conversion apparatus converts the operation description program into the circuit description program based on the plan received from the user. The user can thereby acquire a circuit description program in which a design, which shows the circuit having the spec he/she wants, is described.

In the program conversion apparatus, the generation unit may generate the indicator that includes the spec shown by the received plan.

With this structure, the program conversion apparatus generates the indicator that shows the same spec as the plan. Accordingly, with reference to the outputted indicator, the user can easily judge whether or not the circuit, which is realized in accordance with the design described in the circuit description program, has the spec the user wants.

In the program conversion apparatus, (i) the spec the user wants may be allocation of a hardware element that has been specified by the user, (ii) the plan reception unit may receive, as the plan, a template that contains, in correspondence, (a) a circuit diagram of the hardware element that has been specified by the user and (b) operation information that shows a processing operation of the hardware element that has been specified by the user, and (iii) if the operation description program has a first part that conducts the processing operation shown by the operation information contained in the received template, the conversion unit may generate the circuit description program whose design allocates, to the first part, the hardware element shown by the circuit diagram corresponding to the operation information.

According to the above structure, the program conversion apparatus generates the circuit description program with use of the template received from the user. With the user inputting the template to the program conversion apparatus, the program conversion apparatus can allocate the hardware he/she wants to the circuit that is realized in accordance with the design described in the circuit description program. Accordingly, the user can acquire a circuit description program in which a design, which shows the circuit that is allocated with the hardware specified by the user, is described.

In the program conversion apparatus, (i) the plan reception unit may further receive an allocation pattern that specifies, in the operation description program, an allocatable part that can be allocated with the hardware element shown by the circuit diagram contained in the template, and (ii) the conversion unit may generate the circuit description program whose design allocates the hardware element, which is shown by the circuit diagram corresponding to the operation information, only to the first part that is also specified by the allocation pattern as the allocatable part, and not to the first part that is not specified by the allocation pattern as the allocatable part.

With the above structure, the program conversion apparatus can distinguish, in the operation description program, a part to which the hardware specified by the user is allocated in accordance with the allocation pattern, from a part to which the hardware is not allocated.

In the program conversion apparatus, (i) before the conversion unit performs the conversion, the generation unit may predict (a) the design and (b) the indicator that shows the spec of the circuit that is realized in accordance with the predicted design, and (ii) before the conversion unit performs the conversion, the indicator output unit may output the predicted indicator.

The above structure enables the program conversion apparatus to predict the indicator and output the predicted indicator before converting the operation description program into the circuit description program. This way, the user can acknowledge the predicted indicator before the circuit description program is outputted. Accordingly, based on a result of this prediction, the user can predict in advance whether or not the circuit, which is realized in accordance with the design described in the circuit description program to be outputted, has the spec he/she wants.

In the program conversion apparatus, the generation unit may have prestored therein prediction information that is used for performing the prediction, and predicts the indicator based on the prediction information and the predicted design

The above structure enables the program conversion apparatus to predict the indicator based on the prestored prediction information.

In the program conversion apparatus, (i) the prediction information may be composed of (a) a generated program, which is a circuit description program that has been generated in the past and (b) a generated indicator, which shows a spec of a circuit that is realized in accordance with a design described in the generated program, and (ii) the generation unit may search, in the operation description program, a second part that conducts a same processing operation as a part of the generated program, and predicts the indicator by allocating (a) to the second part, a generated partial indicator that is based on the generated indicator, and (b) to a part of the operation description program other than the second part, a predicted partial indicator that has been predicted.

The above structure enables the program conversion apparatus to predict the indicator based on the generated program and the generated indicator.

The program conversion apparatus may further include a template reception unit operable to receive a template that contains, in correspondence, (i) a circuit diagram of a hardware element that has been specified by a user and (ii) operation information that shows a processing operation of the hardware element that has been specified by the user, wherein if the operation description program has a first part that conducts the processing operation showy by the operation information contained in the received template, the conversion unit predicts the design by allocating, to the first part, the hardware element shown by the circuit diagram corresponding to the operation information.

According to the above structure, the program conversion apparatus generates the circuit description program with use of the template received from the user. With the user inputting the template to the program conversion apparatus, the program conversion apparatus can allocate the hardware he/she wants to the circuit that is realized in accordance with the design described in the circuit description program. Accordingly, the user can acquire a circuit description program in which a design, which shows the circuit that is allocated with the hardware specified by the user, is described.

In the program conversion apparatus, (i) the template reception unit may further receive an allocation pattern that specifies, in the operation description program, an allocatable part that can be allocated with the hardware element shown by the circuit diagram that is contained in the template, and (ii) if the operation description program has a first part that conducts the processing operation shown by the operation information contained in the received template, the generation unit may predict the design by allocating the hardware element, which is shown by the circuit diagram corresponding to the operation information, only to the first part that is also specified by the allocation pattern as the allocatable part, and not to the first part that is not specified by the allocation pattern as the allocatable part.

With the above structure, the program conversion apparatus can distinguish, in the operation description program, a part to which the hardware specified by the user is allocated by the allocation pattern, from a part to which the hardware is not allocated.

In the program conversion apparatus, (i) the spec of the circuit may be an area of the circuit, (ii) the indicator may be an area indicator showing the area of the circuit that is realized in accordance with the design described in the circuit description program, and (iii) the generation unit may (a) acquire respective areas of the one or more hardware elements to be allocated in realizing the circuit, (b) calculate a sum of the acquired areas, and (c) regard the calculated sum as the area indicator.

With the above structure, the program conversion apparatus outputs, as the indicator, the area of the circuit that is described by the circuit description program. Accordingly, with reference to the outputted indicator (area), the user can judge whether or not the circuit, which is realized in accordance with the design described in the circuit description program, has the spec the user wants.

In the program conversion apparatus, (i) the spec of the circuit may be an execution time of the circuit, (ii) the indicator may be an execution time indicator showing the execution time of the circuit that is realized in accordance with the design described in the circuit description program, and (iii) the generation unit may (a) based on the design, determine execution cycles to each of which a different one of the one or more hardware elements to be allocated belongs, (b) based on the determination, acquire a number of the execution cycles and a unit of time per execution cycle, (c) calculate the execution time of the circuit using the acquired number of the execution cycle and the acquired unit of time, and (d) regard the calculated execution time as the execution time indicator.

With the above structure, the program conversion apparatus outputs, as the indicator, the execution time of the circuit described by the circuit description program. Accordingly, with reference to the outputted indicator (execution time), the user can judge whether or not the circuit, which is realized in accordance with the design described in the circuit description program, has the spec the user wants.

In the program conversion apparatus, (i) the spec of the circuit may be a power consumption of the circuit, (ii) the indicator may be a power consumption indicator showing the power consumption of the circuit that is realized in accordance with the design described in the circuit description program, and (iii) the generation unit may (a) calculate the power consumption of the circuit based on a connection condition between the one or more hardware elements shown by the design and (b) regard the calculated power consumption as the power consumption indicator.

With the above structure, the program conversion apparatus outputs, as the indicator, the power consumption of the circuit described by the circuit description program. Accordingly, with reference to the outputted indicator (power consumption), the user can judge whether or not the circuit, which is realized in accordance with the design described in the circuit description program, has the spec he/she wants.

In the program conversion apparatus, (i) the spec of the circuit may be a code size of the circuit description program, and (ii) the generation unit may (a) calculate the code size of the circuit description program and (b) regard the calculated code size as the indicator.

With the above structure, the program conversion apparatus outputs, as the indicator, a code size of a code described by the circuit description program. Accordingly, with reference to the outputted indicator (code size), the user can judge whether or not the circuit, which is realized in accordance with the design described in the circuit description program, has the spec he/she wants.

In the program conversion apparatus, (i) the spec of the circuit may be correlation information showing a correlation between an area and an execution time of the circuit, (ii) the indicator may be a relation information indicator showing the correlation in the circuit that is realized in accordance with the design described in the circuit description program, and (iii) the generation unit may (a) calculate the area and the execution time of the circuit that is realized in accordance with the design, (b) acquire the correlation information based on the calculated area and execution time of the circuit, and (c) regard the acquired correlation information as the relation information indicator.

With the above structure, the program conversion apparatus outputs, as the indicator, the correlation between the area and the execution time of the circuit described by the circuit description program. Accordingly, with reference to the outputted indicator (correlation information), the user can judge whether or not the circuit, which is realized in accordance with the design described in the circuit description program, has the spec he/she wants.

In the program conversion apparatus, (i) the spec of the circuit may be a circuit diagram, (ii) the indicator may be a circuit diagram of the circuit that is realized in accordance with the design described in the circuit description program, and (iii) the generation unit may generate the circuit diagram of the circuit based on a connection condition between the one or more hardware elements shown by the design, and may regard the generated circuit diagram as the indicator.

With the above structure, the program conversion apparatus outputs, as the indicator, the circuit diagram of the circuit described by the circuit description program. Accordingly, with reference to the outputted indicator (circuit diagram), the user can judge whether or not the circuit, which is realized in accordance with the design described in the circuit description program, has the spec he/she wants.

In the program conversion apparatus, (i) the spec of the circuit may be a combined spec that contains at least two of the following: (a) an area of the circuit; (b) an execution time of the circuit; (c) correlation information showing a correlation between the area and the execution time of the circuit; (d) a circuit diagram; and (e) a code size of the circuit description program, (ii) the indicator may be a combined indicator showing the combined spec of the circuit that is realized in accordance with the design described in the circuit description program, (iii) the generation unit may generate the combined indicator, and (iv) the indicator output unit may output the generated combined indicator.

With the above structure, the program conversion apparatus outputs, as the indicator, the combined indicator composed of at least two of the following: (a) the area of the circuit; (b) the execution time of the circuit; (c) the correlation information showing the correlation between the area and the execution time of the circuit; (d) the circuit diagram; and (e) the code size of the circuit description program. Therefore, with reference to the outputted indicator (combined indicator), the user can judge whether or not the circuit, which is realized in accordance with the design described in the circuit description program, has the spec he/she wants.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing a structure of a program conversion apparatus 1;

FIG. 2 is a block diagram showing a structure of a high-level synthesis apparatus 100;

FIG. 3 exemplarily shows how a behavior description D11 is converted into a data flow graph D20;

FIG. 4 is an example of an RTL description D13;

FIG. 5 is a flowchart showing operations of the high-level synthesis apparatus 100;

FIG. 6 is a flowchart showing exemplary operations of generating a program conversion indicator in a conversion indicator generation unit 121;

FIG. 7 is a block diagram showing a structure of a program conversion apparatus 1000;

FIG. 8 is a block diagram showing a structure of a high-level synthesis apparatus 1100;

FIG. 9 shows an example of a template D121;

FIG. 10 exemplarily shows how a data flow graph D131, which is included in the template D121, is utilized;

FIG. 11 shows an example of a graph G10 that is notified by the high-level synthesis apparatus 1100;

FIG. 12 is a flowchart showing operations of the high-level synthesis apparatus 1100; and

FIG. 13 is a flowchart showing exemplary operations of predicting an area and an execution time in an area/execution time prediction unit 1123.

### DESCRIPTION OF THE PREFERRED EMBODIMENT

### 1. First Embodiment

The following describes a program conversion apparatus 1 as incorporated in a first embodiment of the present invention.

1.1 Structure of Program Conversion Apparatus 1

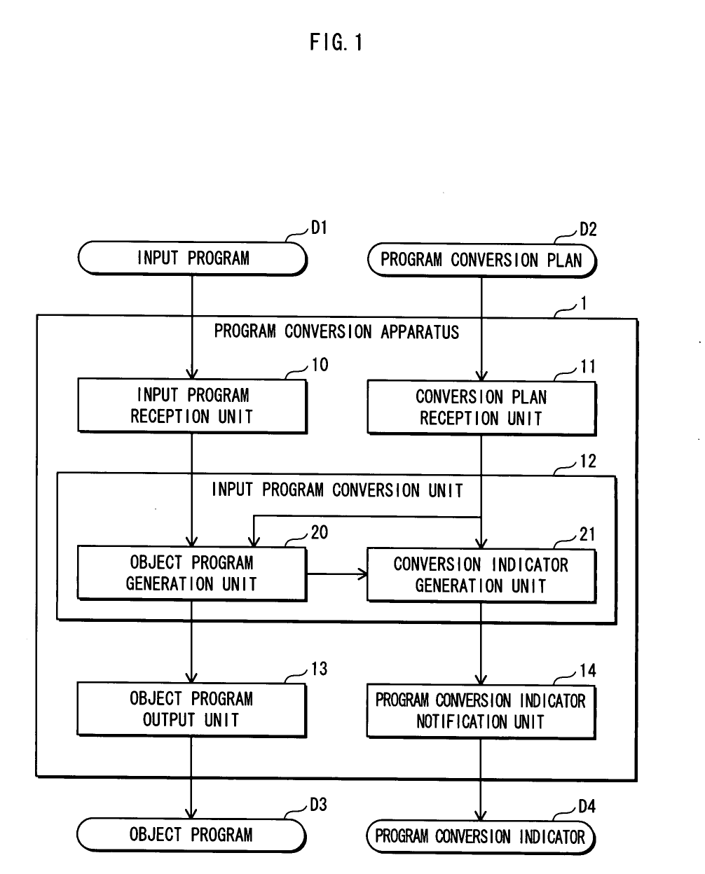

As shown in FIG. 1, the program conversion apparatus 1 includes an input program reception unit 10, a conversion plan reception unit 11, an input program conversion unit 12, an object program output unit 13, and a program conversion indicator notification unit 14.

Specifically, the program conversion apparatus 1 is a computer system composed of a microprocessor, a ROM, a RAM, a hard disk unit, etc. A computer program is stored in the ROM or the hard disk unit. The program conversion apparatus 1 achieves its functions by the microprocessor operating in accordance with the computer program.

The program conversion apparatus 1 converts a program written in a high-level language (hereinafter, “input program”) into another program (hereinafter, “object program”).

The program conversion apparatus 1 receives the input program, which is an object of the conversion, and information indicating a plan for the conversion (hereinafter, “program conversion plan”). Based on the received program conversion plan, the program conversion apparatus 1 converts the input program into the object program, and outputs the post-conversion object program and a program conversion indicator for the object program.

Examples of the program conversion plan include: information for minimizing an execution time of the post-conversion object program; information for minimizing a code size of the post-conversion object program; information for setting the execution time of the object program to or below a predetermined value; and information for minimizing an area of hardware described by the object program (when the object program is hardware technology information).

The program conversion indicator is information corresponding to the inputted program conversion plan. Examples of the program conversion indicator include: the execution time or the code size of the post-conversion object program; and the area of the hardware described by the object program (when the object program is the hardware technology information).

(1) Input Program Reception Unit 10

The input program reception unit 10 receives an input program D1 and outputs the received input program D1 to the input program conversion unit 12.

(2) Conversion Plan Reception Unit 11

The conversion plan reception unit 11 receives a program conversion plan D2 and outputs the received program conversion plan D2 to the input program conversion unit 12.

(3) Input Program Conversion Unit 12

As shown in FIG. 1, the input program conversion unit 12 includes an object program generation unit 20 and a conversion indicator generation unit 21.

(3.1) Object Program Generation Unit 20

The object program generation unit 20 receives the input program D1 from the input program reception unit 10 and the program conversion plan D2 from the conversion plan reception unit 11.

Based on the program conversion plan D2, the object program generation unit 20 converts the input program D1 into an object program D3.

For example, in a case where the program conversion apparatus 1 is a high-level synthesis apparatus, the object program generation unit 20 converts the input program D1 into a program described in RTL. On the other hand, if the program conversion apparatus 1 has a compiling function, the object program generation unit 20 converts the input program D1 into a program described in a machine language (e.g., an assembly language).

The object program generation unit 20 then outputs the generated object program D3 to the object program output unit 13.

(3.2) Conversion Indicator Generation Unit 21

The conversion indicator generation unit 21 generates a program conversion indicator D4 based on the description of the object program generated by the object program generation unit 20.

The conversion indicator generation unit 21 then outputs the generated program conversion indicator D4 to the program conversion indicator notification unit 14.

(4) Object Program Output Unit 13

Upon receiving the object program D3 from the object program generation unit 20 of the input program conversion unit 12, the object program output unit 13 outputs the received object program D3 to, for example, a storage device (not illustrated).

The storage device may be arranged inside or outside the program conversion apparatus 1.

(5) Program Conversion Indicator Notification Unit 14

Upon receiving the program conversion indicator D4 from the conversion indicator generation unit 21 of the input program conversion unit 12, the program conversion indicator notification unit 14 notifies a user of the received program conversion indicator D4.

For example, the program conversion indicator notification unit 14 outputs the program conversion indicator D4 to a display device (not illustrated) connected to the program conversion apparatus 1.

The display device displays the program conversion indicator D4. This way the program conversion indicator notification unit 14 can notify, by means of the display device, the user of the program conversion indicator D4.

1.2 Specific Example of Program Conversion Apparatus 1

The following describes a structure and operations of a high-level synthesis apparatus 100 as a specific example of the program conversion apparatus 1.

(1) Structure of High-level Synthesis Apparatus 100

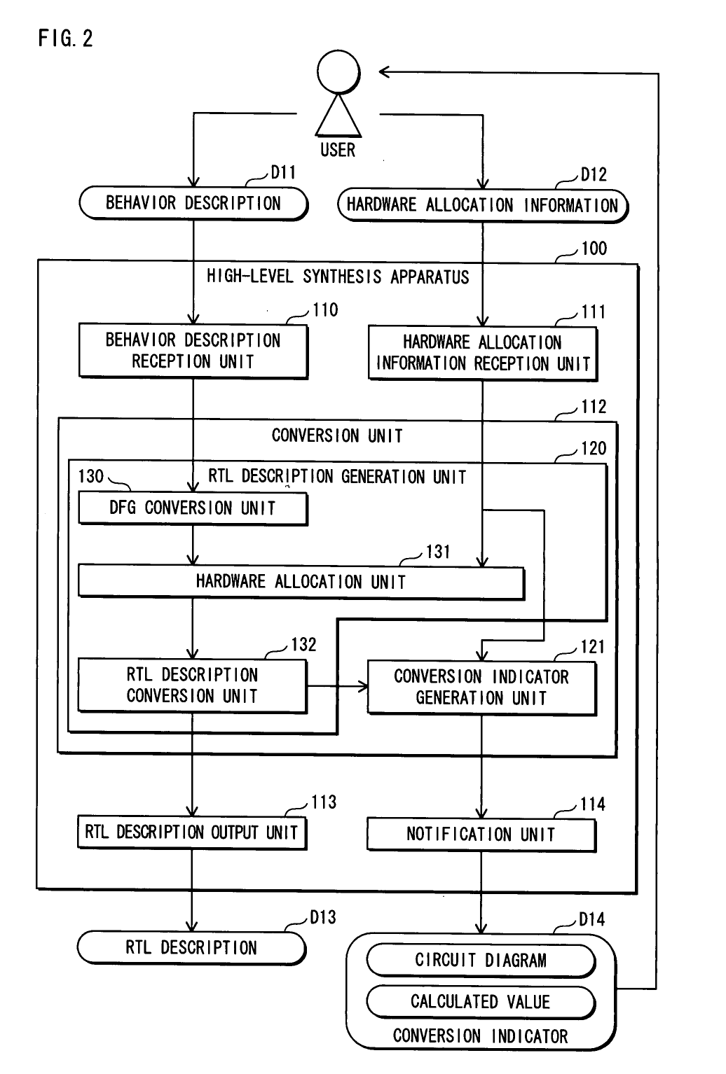

As shown in FIG. 2, the high-level synthesis apparatus 100 includes a behavior description reception unit 110, a hardware allocation information reception unit 111, a conversion unit 112, an RTL description output unit 113, and a notification unit 114.

Specifically, the high-level synthesis apparatus 100 is a computer system composed of a microprocessor, a ROM, a RAM, a hard disk unit, etc. A computer program is stored in the ROM or the hard disk unit. The high-level synthesis apparatus 100 achieves its functions by the microprocessor operating in accordance with the computer program.

The high-level synthesis apparatus 100 receives a program D11 expressed by a behavior description (hereinafter, “behavior description”) as the input program. The high-level synthesis apparatus 100 also receives hardware allocation information D12 as the program conversion plan. Examples of the hardware allocation information D12 include: information for minimizing the area of the hardware described by the object program; and information for minimizing the execution time of the hardware.

Based on the received hardware allocation information D12, the high-level synthesis apparatus 100 converts the behavior description D11 into the object program—i.e., a program D13 described in RTL (hereinafter, “RTL description”). The high-level synthesis apparatus 100 then outputs (i) the post-conversion RTL description D13 and (ii) a conversion indicator D14 that includes a circuit diagram, which is one of the items that comprise the program conversion indicator for the RTL description D13.

With reference to the conversion plan, the user can judge whether or not the high-level synthesis apparatus has generated the RTL description D13 that describes the circuit having the spec he/she wants.

(1.1) Behavior Description Reception Unit 110

The behavior description reception unit 110 is an equivalent of the aforementioned input program reception unit 10.

The behavior description reception unit 110 receives the behavior description D11 from the user and outputs the received behavior description D11 to the conversion unit 112.

Here, the behavior description represents a program written in a high-level language such as the C programming language.

(1.2) Hardware Allocation Information Reception Unit 111

The hardware allocation information reception unit 111 is an equivalent of the aforementioned conversion plan reception unit 11.

The hardware allocation information reception unit 111 receives the hardware allocation information D12 from the user, and outputs the received hardware allocation information D12 to the conversion unit 112.

(1.3) Conversion Unit 112

The conversion unit 112 is an equivalent of the aforementioned input program conversion unit 12.

As shown in FIG. 2, the conversion unit 112 includes an RTL description generation unit 120 and a conversion indicator generation unit 121.

(1.3.1) RTL Description Generation Unit 120

The RTL description generation unit 120 is an equivalent of the aforementioned object program generation unit 20, whereas the conversion indicator generation unit 121 is an equivalent of the aforementioned conversion indicator generation unit 21.

As shown in FIG. 2, the RTL description generation unit 120 includes a DFG conversion unit 130, a hardware allocation unit 131 and an RTL description conversion unit 132.

(DFG Conversion Unit 130)

The DFG conversion unit 130 receives the behavior description D11 from the behavior description reception unit 110.

The DFG conversion unit 130 converts the received behavior description D11 into a data flow graph (DFG) D20, and outputs the post-conversion data flow graph D20 to the hardware allocation unit 131.

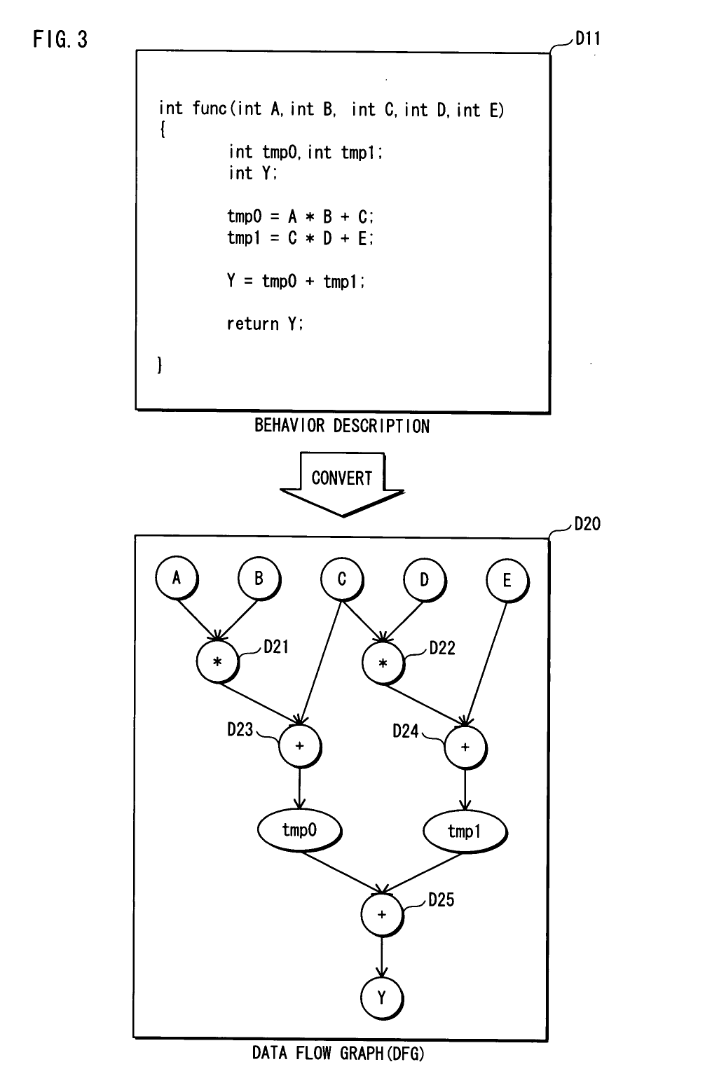

The data flow graph is a directed graph. Processing described by the behavior description is converted into the directed graph by expressing operations of the behavior description as nodes. FIG. 3 exemplarily shows how the behavior description D11 is converted into the data flow graph D20. The data flow graph D20 contains nodes D21, D22, D23, D24 and D25 as nodes that express operations. The nodes D21 and D22 show multiplication, whereas the nodes D23, D24 and D25 show addition.

Note that a method for converting the behavior description into DFG is publicly known, and thus its description is omitted here.

(Hardware Allocation Unit 131)

The hardware allocation unit 131 receives the hardware allocation information D12 from the hardware allocation information reception unit 111, and the data flow graph D20 from the DFG conversion unit 130.

Based on the received hardware allocation information D12 and with use of the data flow graph D20, the hardware allocation unit 131 allocates hardware.

The following describes exemplary operations of allocating the hardware.

The object program to be generated by the high-level synthesis apparatus 100 is an RTL description. As the RTL description is a circuit diagram, it comprises one or more arithmetic logic units (ALUS) that are connected to one another. In the course of converting the behavior description D11 into the RTL description, the hardware allocation is a process for determining how to allocate the ALUs to the operation nodes of the data flow graph D20, which is obtained by converting the behavior description.

For example, the data flow graph D20 in FIG. 3 includes two multiplication nodes D21 and D22 and three addition nodes D23, D24 and D25. In a case where the hardware allocation information is the information for minimizing the execution time of the hardware, the hardware allocation unit 131 prepares two multipliers, and allocates one multiplier to the node D21 and the other to the node D22, so that each multiplier executes an operation on a different node. This way two multiplications can be executed in parallel. Similarly, the hardware allocation unit 131 allocates a single adder to each one of the addition nodes D23, D24 and D25 as well. This allocation method can minimize the execution time of the hardware. As one ALU is generally permitted to execute its operation only once per cycle, the above allocation method enables all of the five allocated ALUs to execute their operations in one cycle. In this case, however, as a different ALU is allocated to each one of the operation nodes, the hardware area is naturally large.

In contrast, in a case where the hardware allocation information is the information for minimizing the hardware area, the hardware allocation is conducted in a manner different from the one described above. For example, the hardware allocation unit 131 allocates one same multiplier to the multiplication nodes D21 and D22. In this structure, although-two operations (multiplications) cannot be executed in parallel, the hardware area is smaller than the above case because there is only one multiplier. Similarly, the hardware allocation unit 131 allocates one same adder to the addition nodes D23, D24 and D25.

(RTL Description Conversion Unit 132)

Based on the ALU allocation conducted by the hardware allocation unit 131, the RTL description conversion unit 132 generates the RTL description D13 and outputs the generated RTL description D13 to the RTL description output unit 113.

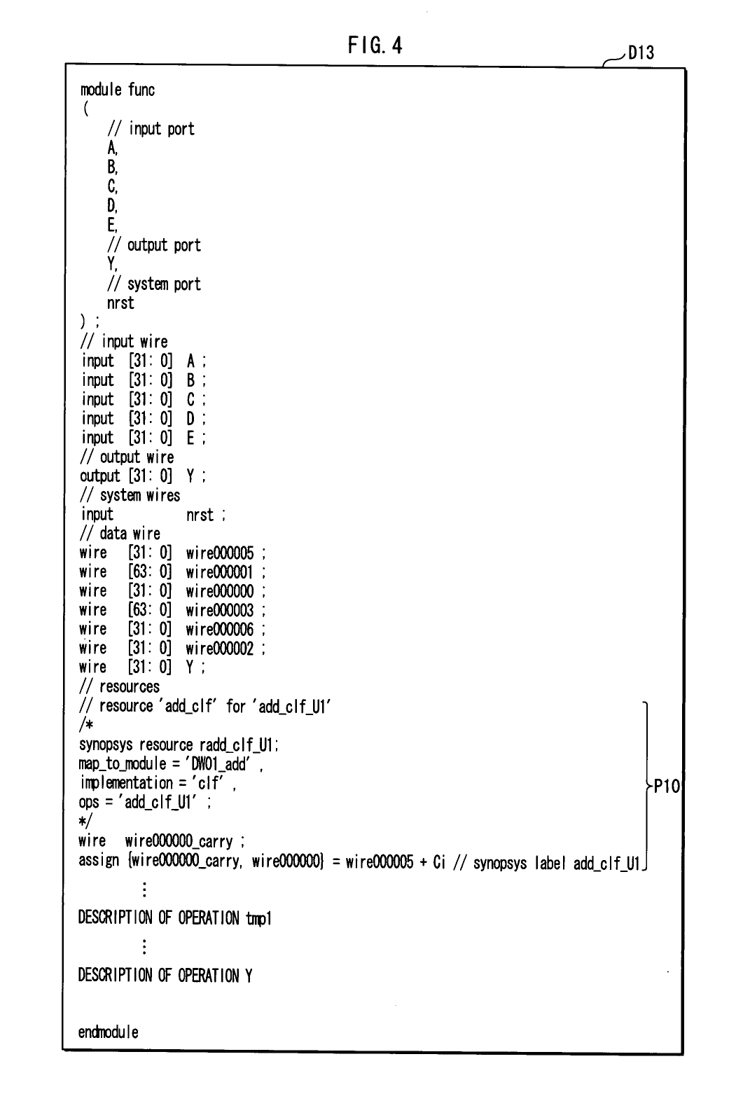

FIG. 4 shows a part of the RTL description D13 that is based on the behavior description shown in FIG. 3. The RTL description D13 shown in FIG. 4 first declares a data type in a wire description, and then describes an operation tmp0 in a description P10. P10 is followed by the descriptions of operations tmp1 and Y. The details of the RTL description are publicly known, and therefore its description is omitted here.

(1.3.2) Conversion Indicator Generation Unit 121

The conversion indicator generation unit 121 generates a circuit diagram based on hardware information described by the RTL description D13, which has been generated by the RTL description conversion unit 132. Also, in accordance with the information shown by the hardware allocation information, the conversion indicator generation unit 121 calculates, from the generated circuit diagram, values expressing the area of the hardware, the execution time of the hardware, etc. (hereinafter, “calculated values”). The conversion indicator generation unit 121 then outputs the circuit diagram and the calculated value as the conversion indicator D14 to the notification unit 114.

For example, in the case where the hardware allocation information shows the information for minimizing the hardware area, the conversion indicator generation unit 121 acquires a respective area of each different ALU based on the hardware information described by the RTL description D13, which has been generated by the RTL description conversion unit 132. Then, the conversion indicator generation unit 121 calculates a sum of the acquired areas, and outputs, to the notification unit 114, the calculated sum of the areas as the calculated value together with the circuit diagram.

Here, it is permissible that the high-level synthesis apparatus 100 has stored the respective area of each different ALU in advance, or receives the same from the user. Or, the high-level synthesis apparatus 100 may acquire the respective area of each different ALU from an outside apparatus.

On the other hand, in the case where the hardware allocation information shows the information for minimizing the execution time of the hardware, the conversion indicator generation unit 121 calculates, based on the hardware information shown by the RTL description D13, the execution time of the hardware with use of the following computing equation: [the number of execution cycles×a time required for one cycle (in seconds)]. The conversion indicator generation unit 121 outputs, to the notification unit 114, the calculated execution time as the calculated value together with the circuit diagram. Note that “the number of execution cycles” and “the time required for one cycle”, which are parameters of the above computing equation, can be acquired from the generated DFG.

(1.4) RTL Description Output Unit 113

The RTL description output unit 113 is an equivalent of the aforementioned object program output unit 13′.

Upon receiving the RTL description D13 from the RTL description conversion unit 132, the RTL description output unit 113 outputs the received RTL description D13 to a storage device (e.g., a hard disk unit).

An output destination of the RTL description D13 is not confined to the hard disk unit. The RTL description D13 may be output to'any destination as long as the destination has an area that can store the RTL description D13.

(1.5) Notification Unit 114

The notification unit 114 is an equivalent of the aforementioned program conversion indicator notification unit 14.

Upon receiving the circuit diagram and the calculated value from the conversion indicator generation unit 121, the notification unit 114 notifies the user of the received circuit diagram and the calculated value as the conversion indicator D14.

For example, the notification unit 114 outputs the conversion indicator D14 to a display device (not illustrated) that is connected to the high-level synthesis apparatus 100. The display device then displays the conversion indicator D14. This way, the notification unit 114 can notify, by means of the display device, the user of the conversion indicator D14.

(2) operations of High-Level Synthesis Apparatus 100

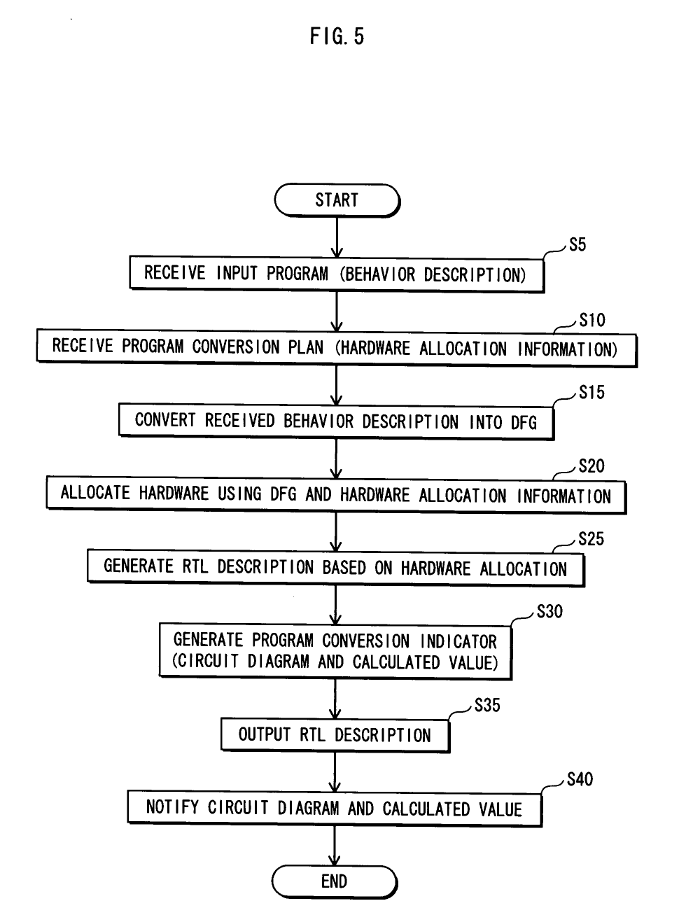

Referring to a flowchart shown in FIG. 5, the following describes operations of the high-level synthesis apparatus 100.

The behavior description reception unit 110 receives the behavior description D11 from the user (Step S5).

The hardware allocation information reception unit 111 receives the hardware allocation information D12 from the user (Step S10).

The DFG conversion unit 130 converts the received behavior description D11 into the data flow graph D20 (Step S15).

Based on the received hardware allocation information D12, the hardware allocation unit 131 allocates the hardware (ALU) with use of the data flow graph D20 (Step S20).

Based on the ALU allocation conducted by the hardware allocation unit 131, the RTL description conversion unit 132 generates the RTL description D13 (Step S25).

The conversion indicator generation unit 121 generates the program conversion indicator by (i) generating the circuit diagram based on the hardware information described by the RTL description D13, which has been generated by the RTL description conversion unit 132, and (ii) calculating, from the generated circuit diagram, the calculated value with use of the information shown by the hardware allocation information (Step S30).

The RTL description output unit 113 outputs the generated RTL description D13 to the storage device (Step S35).

The notification unit 114 notifies the user of the conversion indicator D14 by outputting, to the display device, the generated circuit and the calculated value as the conversion indicator D14 (Step S40).

(3) Example of Generating Program Conversion Indicator

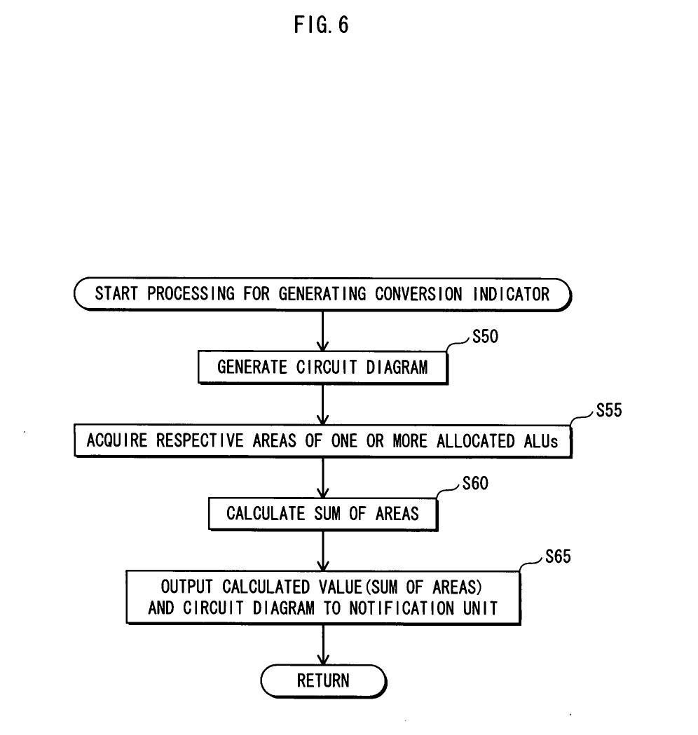

Referring to a flowchart shown in FIG. 6, the following describes exemplary operations of generating the program conversion indicator in the Step S30 shown in FIG. 5.

Note that the calculated value represents the area of the hardware.

The conversion indicator generation unit 121 generates the circuit diagram based on the hardware information described by the RTL description D13, which has been generated by the RTL description conversion unit 132 (Step S50).

The conversion indicator generation unit 121 acquires the area of the different one of the one or more allocated ALUs, based on the hardware information described by the RTL description D13, which has been generated by the RTL description conversion unit 132 (Step S55).

The conversion indicator generation unit 121 calculates a sum of the one or more acquired areas (Step S60).

The conversion indicator generation unit 121 outputs, to the notification unit 114, the sum of the areas as the calculated value together with the circuit diagram (Step S65).

Note that in Step S55, the conversion indicator generation unit 121 may acquire the area of the different one of the ALUs either (i) from a storage unit that has stored it in advance, or (ii) by receiving it from the user. Or, the conversion indicator generation unit 121 may acquire the same from an outside apparatus.

(4) Summary of Specific Example

As set forth above, the high-level synthesis apparatus receives the input program (program expressed by the behavior description) and the program conversion plan (the hardware allocation information), and outputs the object program (the program expressed by the RTL description) and the program conversion indicator (the circuit diagram and the calculated value).

Depending on the spec that the user wants (e.g., the smallest area, the shortest execution time, etc.), the RTL description outputted by the high-level synthesis apparatus has a different best method for allocating the ALU.

As has been stated in the above specific example, the high-level synthesis apparatus receives the hardware allocation information as an input and outputs the program conversion indicator. This enables the user of the apparatus to readily specify the ALUs that are respectively allocated to operations shown in DFG, or to acknowledge the allocated ALUs, the number of the allocated ALUs, the area of the circuit, etc. by referencing the output circuit diagram.

Also, the above high-level synthesis apparatus notifies the user of the program conversion indicator (the circuit diagram and the calculated value). Accordingly, with reference to the circuit diagram and the calculated value that have been notified by the high-level synthesis apparatus 100, the user can judge whether or not the generated circuit has the spec he/she wants. If judging the circuit does not have the spec, the user re-examines the hardware allocation information, and inputs a behavior description and the re-examined hardware allocation information into the high-level synthesis apparatus 100. By repeating such operations, the user can acquire the circuit having the spec he/she wants.

With reference to the circuit diagram, the user of the apparatus can also readily judge easiness of the hardware testing. In view of the circuit diagram, the user of the apparatus develops an idea about hardware that can be tested more easily. The idea of the user is inputted again into the high-level synthesis apparatus as the program conversion plan (here, the hardware allocation information). The high-level synthesis apparatus 100 then re-performs high-level synthesis tasks, and should output hardware information (information based on the RTL description) that can be tested more easily than the one that was generated by the high-level synthesis earlier. As the user repeats the above operations, the high-level synthesis apparatus generates hardware information that can be tested more easily than ever. If the high-level synthesis is repeated until the easiness of the hardware testing reaches the level required by the user, the user can acquire hardware information that has his/her demand in the end.

### 2. Second Embodiment

Described below is a program conversion apparatus 1000 as incorporated in a second embodiment of the present invention.

2.1 Structure of Program Conversion Apparatus 1000

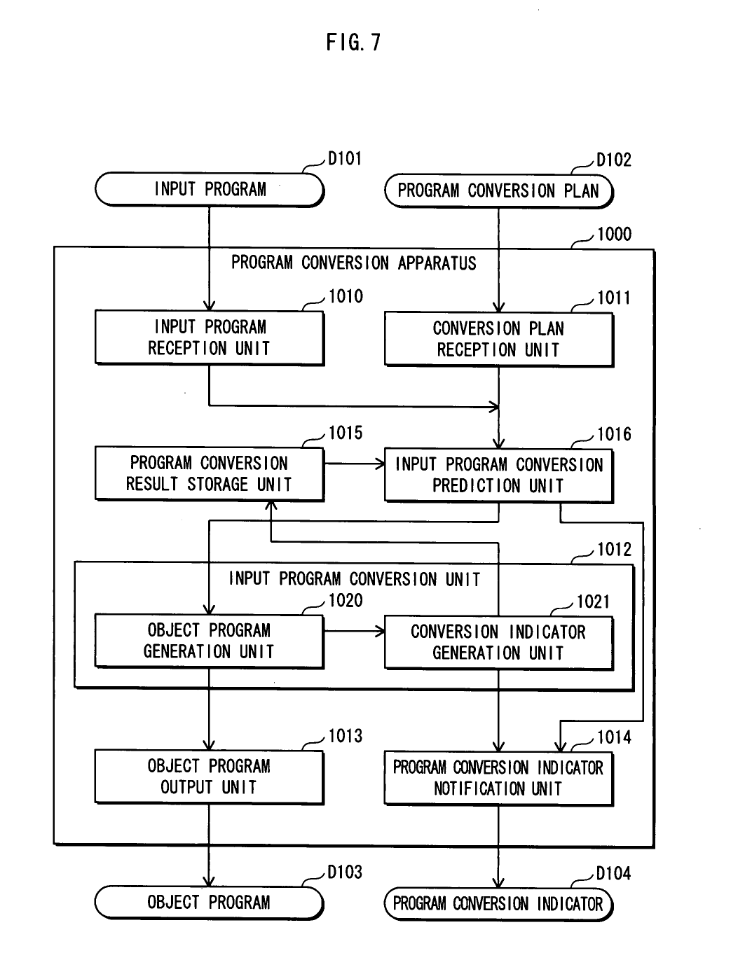

As shown in FIG. 7, the program conversion apparatus 1000 includes an input program reception unit 1010, a conversion plan reception unit 1011, an input program conversion unit 1012, an object program output unit 1013, a program conversion indicator notification unit 1014, a program conversion result storage unit 1015, and an input program conversion prediction unit 1016.

Specifically, the program conversion apparatus 1000 is a computer system composed of a microprocessor, a ROM, a RAM, a hard disk unit, etc. A computer program is stored in the ROM or the hard sick unit. The program conversion apparatus 1000 achieves its functions by the microprocessor operating in accordance with the computer program.

As with the program conversion apparatus 1 in the first embodiment, the program conversion apparatus 1000 converts an input program into an object program.

The program conversion apparatus 1000 receives the input program, which is an object of the conversion, and a program conversion plan. Based on the received program conversion plan, the program conversion apparatus 1000 predicts a result of converting the input program into the object program, and notifies a result of the prediction to the user.

The user references the notified prediction result. If there is no problem with the program conversion plan the user has inputted, the user inputs information for instructing the conversion of the input program (hereinafter, “conversion instruction”). If the user wants to make a change to the program conversion plan he/she has inputted, the user re-inputs a program conversion plan.

If the program conversion apparatus 1000 receives the conversion instruction after notifying the prediction result to the user, the program conversion apparatus 1000 converts the input program in accordance with the program conversion plan, and outputs the post-conversion object program and the program conversion indicator for the object program.

If the program conversion apparatus 1000 re-receives the program conversion plan after notifying the prediction result to the user, the program conversion apparatus 1000 predicts a result of converting the input program into the object program based on the re-received program conversion plan, and notifies the prediction result to the user.

As in the first embodiment, examples of the program conversion plan include: information for minimizing the execution time of the post-conversion object program; information for minimizing the code size of the post-conversion object program; information for setting the execution time of the object program to or below the predetermined value; and information for minimizing the area of the hardware described by the object program (when the object program is the hardware technology information).

As in the first embodiment, the program conversion plan is information that corresponds to the input program conversion plan. Examples of the program conversion plan include the execution time or the code size of the post-conversion object program, and when the object program is the hardware technology information, the area of the hardware described by the object program.

(1) Input Program Reception Unit 1010

The input program reception unit 1010 receives an input program D101, and outputs the received input program D101 to the input program conversion prediction unit 1016.

(2) Conversion Plan Reception Unit 1011

The conversion plan reception unit1011 receives a program conversion plan D102, and outputs the received program conversion plan D102 to the program conversion-prediction unit 1016.

Upon receiving a conversion instruction from the user, the conversion plan reception unit 1011 outputs the received conversion instruction to the input program conversion prediction unit 1016.

(3) Program Conversion Result Storage Unit 1015

The program conversion result storage unit 1015 has an area for storing (i) one or more object programs that have been converted in the past and (ii) pieces of use information that are in one-to-one correspondence with the one or more object programs that have been converted in the past, and that are used for predicting the conversion.

Examples of the use information include: the execution time of the object program; the code size of the object program; and the area of the hardware described by the object program (when the object program is hardware technology information).

(4) Input Program Conversion Prediction Unit 1016

The input program conversion prediction unit 106 receives the input program D101 from the input program reception unit 1010, and temporarily stores therein the received input program D101.

The input program conversion prediction unit 1016 receives either the conversion instruction or the program conversion plan D102 from the conversion plan reception unit 1011.

The input program conversion prediction unit 1016 judges which one of the above two it has received from the conversion plan reception unit 1011. If the input program conversion prediction unit 1016 judges it has received the conversion instruction, it outputs the received conversion instruction to the input program conversion unit 1012.

On the other hand, if the input program conversion prediction unit 1016 judges it has received the program conversion plan D102, it temporarily stores therein the received program conversion plan D102 and executes the following operations.

Based on the received program conversion plan D102, and with use of (i) the one or more object programs and (ii) the pieces of use information corresponding thereto that are both stored in the program conversion result storage unit 1015, the input program conversion prediction unit 1016 predicts a program conversion indicator for the object program corresponding to the input program D101.

The input program conversion prediction unit 1016 outputs the prediction result to the object program output unit 1013.

Here, the prediction result is information that corresponds to the received program conversion plan. For example, in a case where the program conversion plan is information for minimizing the execution time of the object program, the prediction result shows the execution time of the object program. Similarly, in a case where the program conversion plan is information for minimizing the code size of the object program, the prediction result shows the code size of the object program. In a case where the program conversion plan is information for minimizing the area of the hardware described by the object program, the prediction result shows the area of the hardware described by the object program.

(5) Input Program Conversion Unit 1012

As shown in FIG. 7, the input program conversion unit 1012 includes an object program generation unit 1020 and a conversion indicator generation unit 1021.

(5.1) Object Program Generation Unit 1020

Upon receiving the conversion instruction from the input program conversion prediction unit 1016, the object program generation unit 1020 converts the input program D101, which is temporarily stored in the input program conversion prediction unit 1016, into an object program D103 that complies with the prediction result.

The object program generation unit 1020 outputs the generated object program D103 to the object program output unit 1013.

(5.2) Conversion Indicator generation unit 1021

The conversion indicator generation unit 1021 acquires (i) the object program D103 generated by the object program generation unit 1020 and (ii) by using the prediction made by the input program conversion prediction unit 1016, the use information. The conversion indicator generation unit 1021 stores the object program D103 and the acquired use information into the program conversion result storage unit 1015.

Then, the conversion indicator generation unit 1021 generates a program conversion indicator D104 based on a description of the object program D103, which has been generated by the object program generation unit 1020, and outputs the generated program conversion indicator D104 to the program conversion indicator notification unit 1014.

(6) Object Program Output Unit 1013

An explanation of the object program output unit 1013 is omitted here, since it executes the same operations as the object program output unit 13, which is described in the first embodiment.

(7) Program Conversion Indicator Notification Unit 1014

Upon receiving the prediction result from the input program conversion prediction unit 1016, the program conversion indicator notification unit 1014 notifies the user of the received prediction result.

Upon receiving the program conversion indicator D104 from the input program conversion unit 1012, the program conversion indicator notification unit 1014 notifies the user of the received program conversion indicator D104.

For example, the program conversion indicator notification unit 1014 outputs the program conversion indicator D104 to a display device (not illustrated) that is connected to the program conversion apparatus 1000.

The display device displays the program conversion indicator D104. This way, the program conversion indicator notification unit 1014 can notify, by means of the display device, the user of the program conversion indicator D4.

2.2 Specific Example of Program Conversion Apparatus 1000

The following describes a structure and operations of a high-level synthesis apparatus 1100 as a specific example of the program conversion apparatus 1000.

(1) Structure of High-Level Synthesis Apparatus 1100

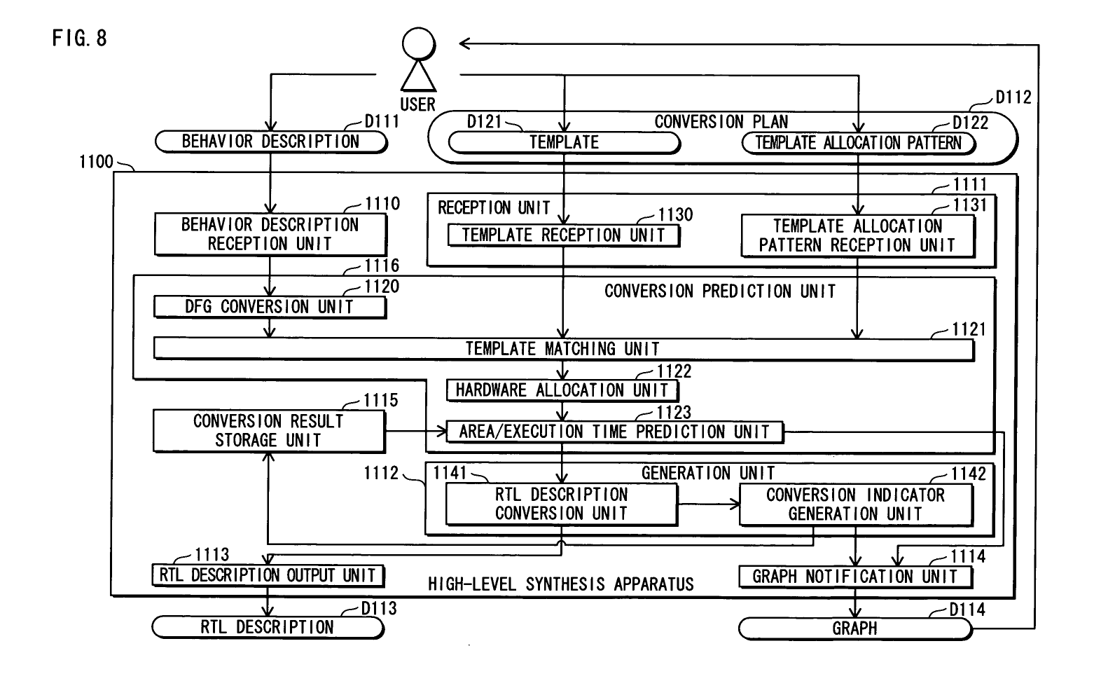

As shown in FIG. 8, the high-level synthesis apparatus 1100 includes: a behavior description reception unit 1110; a reception unit 1111; a generation unit 1112; an RTL description output unit 1113; a graph notification unit 1114; a conversion result storage unit 1115; and a conversion prediction unit 1116.

Specifically, the high-level synthesis apparatus 1100 is a computer system composed of a microprocessor, a ROM, a RAM, a hard disk unit, etc. A computer program is stored in the ROM or the hard disk unit. The high-level synthesis apparatus 1100 achieves its functions by the microprocessor operating in accordance with the computer program.

The high-level synthesis apparatus 1100 receives a behavior description D111 as the input program and a conversion plan D112 as the program conversion plan.

Based on the received conversion plan D112, the high-level synthesis apparatus 1100 converts the behavior description D111 into an RTL description D113, which is the object program, and outputs the post-conversion RTL description D113 and a graph D114 that is the program conversion indicator for the RTL description D113. The graph D114 is, for example, a graph indicating the relationship between the execution time and the area of the hardware.

With reference to the graph D114, the user can judge whether or not the apparatus has generated the RTL description D113 that describes the circuit having the spec the user wants.

(1.1) Behavior Description Reception Unit 1110

The behavior description reception unit 1110 is an equivalent of the aforementioned input program reception unit 1010.

The behavior description reception unit 1110 receives the behavior description D111 from the user, and outputs the received behavior description D111 to the conversion prediction unit 1116.

(1.2) Reception Unit 1111

The reception unit 1111 is an equivalent of the aforementioned conversion plan reception unit 1011.

The reception unit 1111 receives the conversion plan D112 and the conversion instruction from the user.

Here, the conversion plan D112 is either information composed of a template D121 and a template allocation pattern D122, or information consisting only of the template D121.

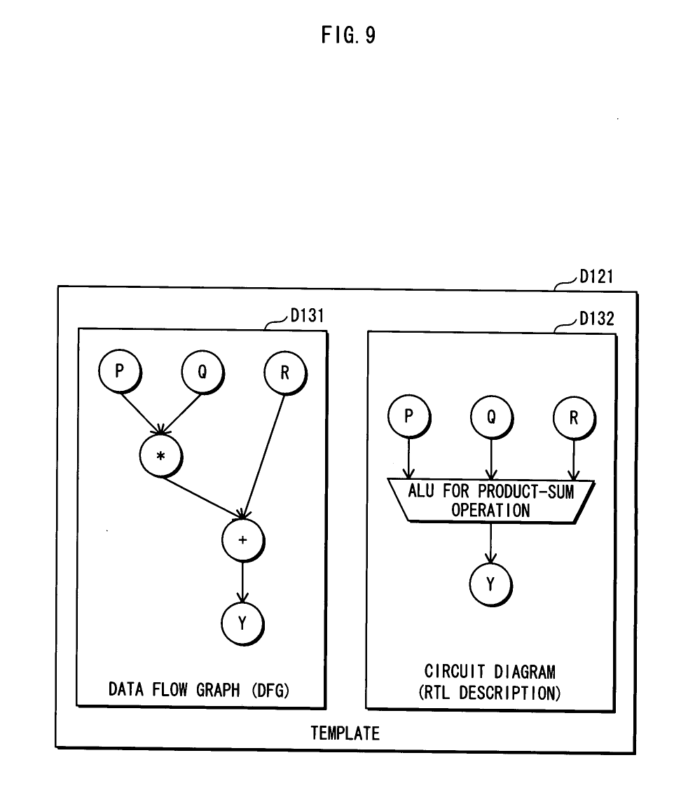

The template D121 contains a combination of (i) a data flow graph (DFG) and (ii) an RTL description of a circuit shown by the DFG. An example of the template D121 is shown in FIG. 9. Note that in FIG. 9, the RTL description is shown in the form of a circuit diagram for the purpose of simplicity. A data flow graph D131, which is contained in the template D121 shown in FIG. 9, shows an operation [Y=P×Q+R]. A circuit diagram (RTL description) D132 is a circuit diagram shown by the data flow graph D131. Operations (multiplication and addition) of the data flow graph D131 can be executed with use of ALUs that perform a product-sum operation.

For example, the template allocation pattern D122 is information for specifying, in the input program, (i) a part to which the template D121 is allocated and (ii) a part to which the template D121 is not allocated.

Upon receiving the conversion instruction, the reception unit 1111 outputs the received conversion instruction to the conversion prediction unit 1116.

As shown in FIG. 8, the reception unit 1111 includes a template reception unit 1130 and a template allocation pattern reception unit 1131.

Upon receiving the template D121 from the user, the template reception unit 1130 outputs the received template D121 to the conversion prediction unit 1116.

Upon receiving the template allocation pattern D122 from the user, the template allocation pattern reception unit 1131 outputs the received template allocation pattern D122 to the conversion prediction unit 1116.

(1.3) Conversion Result Storage Unit 1115

The conversion result storage unit 1115 is an equivalent of the program conversion result storage unit 1015.

The conversion result storage unit 1115 has an area for storing the RTL description which has been converted from the behavior description, and the use information thereof.

Here, the use information is composed of the area and the execution time of the hardware described by the RTL description.

(1.4) Conversion Prediction Unit 1116

The conversion prediction unit 1116 is an equivalent of the input program conversion prediction unit 1016.

The conversion prediction unit 1116 receives the behavior description D111 from the behavior description reception unit 1110, and temporarily stores therein the received behavior description D111.

The conversion prediction unit 1116 receives, from the reception unit 1111, either the conversion instruction or the conversion plan D112.

The conversion prediction unit 1116 judges which one of the above two it has received from the reception unit 1111. If the conversion prediction unit 1116 judges it has received the conversion instruction, it outputs the received conversion instruction to the generation unit 1112.

On the other hand, if the conversion prediction unit 1116 judges it has received the conversion plan D112, it temporarily stores therein the received conversion plan D112.

As shown in FIG. 8, the conversion prediction unit 1116 includes a DFG conversion unit 1120, a template matching unit 1121, a hardware allocation unit 1122, and an area/execution time prediction unit 1123.

(DFG Conversion Unit 1120)

The DFG conversion unit 1120 receives the behavior description D111 from the behavior description reception unit 1110.

The DFG conversion unit 1120 converts the received behavior description D111 into the data flow graph (DFG), and outputs the post-conversion data flow graph to the template matching unit 1121.

As a method for converting the behavior description into the DFG is publicly known, its description is omitted here.

(Template Matching Unit 1121)

The template matching unit 1121 performs a processing for searching, in the data flow graph that has been converted by the DFG conversion unit 1120, a part that has the same shape as a part of the data flow graph D131 contained in the template D121.

The template matching unit 1121 receives the conversion plan from the reception unit 1111 and the data flow graph from the DFG conversion unit 1120.

For example, if the conversion plan D112 is comprised of both of the template D121 and the template allocation pattern D122, the template matching unit 1121 receives the template D121 from the template reception unit 1130 and the template allocation pattern D122 from the template allocation pattern reception unit 1131. On the other hand, if the conversion plan D112 consists only of the template D121, the template matching unit 1121 receives the template D121 from the template reception unit 1130.

In accordance with the received conversion plan D112, the template matching unit 1121 searches, in the converted data flow graph, the part that has the same shape as the part of the data flow graph D131 contained in the template D121—the part that can thus be allocated with the hardware.

(Hardware Allocation Unit 1122)

Based on a result of the search conducted by the template matching unit 1121, the hardware allocation unit 1122 allocates the hardware to the converted data flow graph.

Here, to the part of the converted data flow graph that can be allocated with the template D121, the hardware allocation unit 1122 allocates the template D121. In contrast, to a part of the converted data flow graph that cannot be allocated with the template D121, the hardware allocation unit 1122 allocates ALUs by the same method described in the first embodiment.

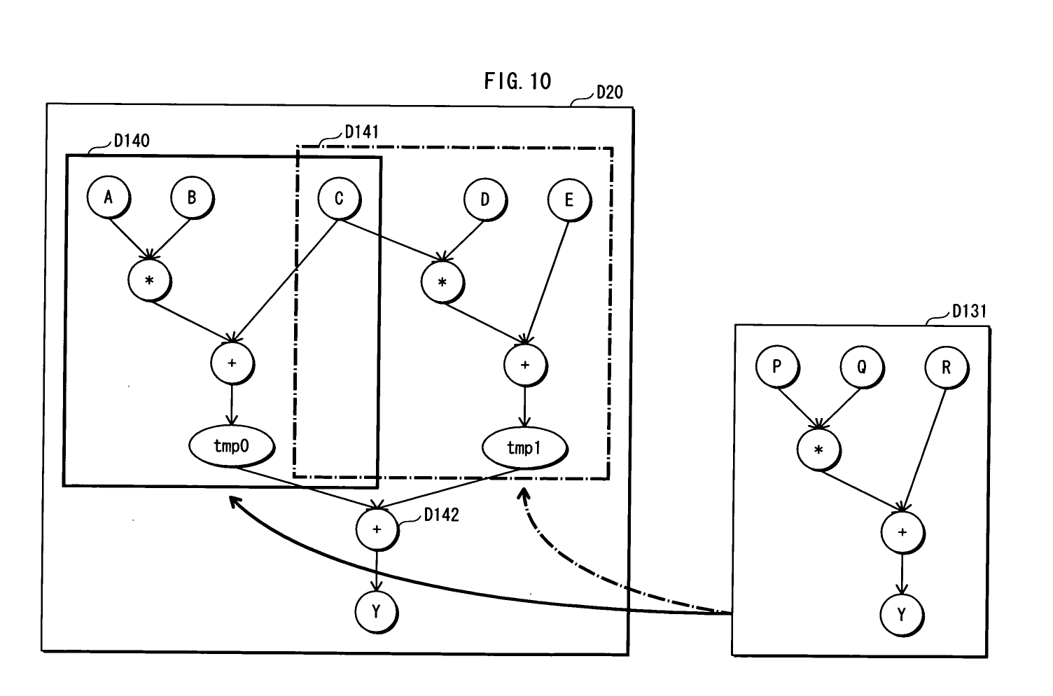

Referring to FIG. 10, the following describes a case where the data flow graph D131 shown in FIG. 9 is allocated to the data flow graph D20 shown in FIG. 3. Note that the conversion plan D112 here consists only of the template D121.

The template matching unit 1121 searches the part of the data flow graph D20 that matches a part of the data flow graph D131, and acquires partial data flow graphs D140 and D141 from the data flow graph D20.

The hardware allocation unit 1122 allocates the data flow graph D131 to the partial data flow graphs D140 and D141, and an adder to an operation node D142.

If the high-level synthesis apparatus 1100 receives, as the template allocation pattern D122, information for allocating the data flow graph D131 only to the partial data flow graph D140 and not to other parts of the data flow graph D20, the hardware allocation unit 1122 allocates the data flow graph D131 to the partial data flow graph D140 while allocating ALUs to other operation nodes by the same allocation method described in the first embodiment.

(Area/Execution Time Prediction Unit 1123)

The area/execution time prediction unit 1123 predicts a program conversion indicator for the object program corresponding to the input program, based on (i) a result of the ALU allocation conducted by the hardware allocation unit 1122 and (ii) one or more RTL descriptions and pieces of use information, which are in one-to-one correspondence with the one or more RTL descriptions, that are stored in the conversion result storage unit 1115. Here, the area/execution time prediction unit 1123 generates, as the prediction result of the program conversion indicator, a graph indicating the relationship between the execution time and the area of the hardware described by the object program (RTL description).

The area/execution time prediction unit 1123 outputs the generated graph to the graph notification unit 1114.

The following describes a method for generating the graph.

The area/execution time prediction unit 1123 plots, on a two-dimensional plane, pieces of use information (area and execution time) each of which corresponds to a different one of ALU allocation patterns (hereinafter, “actual allocation patterns”) that are described by the one or more RTL descriptions stored in the conversion result storage unit 1115. On the two-dimensional plane, a horizontal axis represents the area while a vertical axis represents the execution time. Accordingly, coordinates to be plotted are (area, execution time).

The area/execution time prediction unit 1123 compares (i) one or more actual allocation patterns with (ii) the ALU allocation pattern set by the hardware allocation unit 1122 (hereinafter, “tentative allocation pattern”). After the comparison, with regard to a part of the tentative allocation pattern that is identical to a part of the actual allocation patterns, the area/execution time prediction unit 1123 calculates an area and an execution time of the identical part of the tentative allocation pattern with use of the actual allocation pattern. With regard to a part of the tentative allocation pattern that is different from any part of the actual allocation pattern, the area/execution time prediction unit 1123 calculates an area and an execution time of the different part of the tentative allocation pattern with use of the tentative allocation pattern. Then, the area/execution time prediction unit 1123 acquires a sum of each area and a sum of each execution time, and plots them on the two-dimensional plane.

With use of the plotted coordinates and a least squares method, the area/execution time prediction unit 1123 generates a graph indicating the relationship between the area and execution time of the hardware that is described by the object program (RTL description) corresponding to the input program.

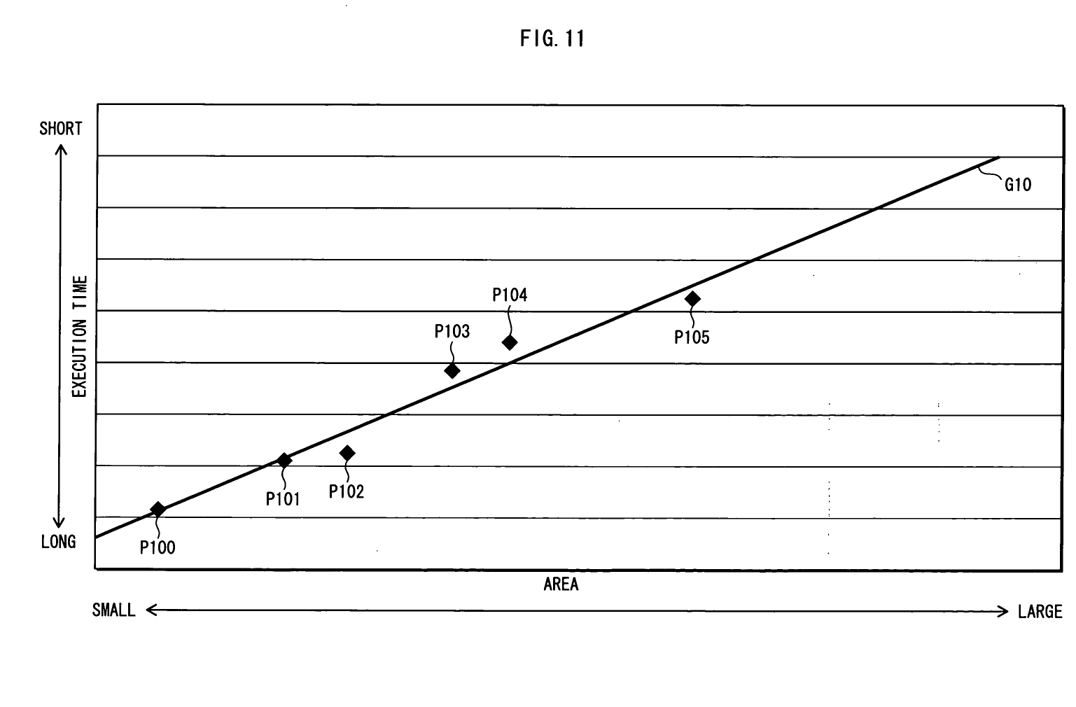

FIG. 11 shows an example of a graph G10 generated by the area/execution time prediction unit 1123. In FIG. 11, a horizontal axis represents the area; the area becomes larger as it gets closer to a right-hand end of the horizontal axis.

On the other hand, the vertical axis represents the execution time; the execution time becomes shorter as it gets closer to an upper end of the vertical axis.

First, on the two-dimensional plane, the area/execution time prediction unit 1123 plots coordinates P100 to P104 that are pieces of use information (area and execution time) which are in one-to-one correspondence with one or more actual allocation patterns. Next, the area/execution time prediction unit 1123 plots coordinates P105 that corresponds to the tentative allocation pattern. Applying the least squares method to the plotted coordinates P100 to P105 yields the graph G10.

Although incorporated in the aforementioned method for generating the graph, the least squares method is not necessarily required. The graph may be generated by any other methods, as long as the methods can generated the graph for sure.

(1.5) Generation-Unit 1112

The generation unit 1112 is an equivalent of the aforementioned input program conversion unit 1012, and as shown in FIG. 8, includes an RTL description conversion unit 1141 and a conversion indicator generation unit 1142.

The RTL description conversion unit 1141 is an equivalent of the aforementioned object program generation unit 1020, whereas the conversion indicator generation unit 1142 is an equivalent of the aforementioned conversion indicator generation unit 1021.

(RTL Description Conversion Unit 1141)

Upon receiving the conversion instruction from the conversion prediction unit 1116, the RTL description conversion unit 1141 generates the RTL description D113 by converting the behavior description D111, which is temporarily stored in the conversion prediction unit 1116, into the RTL description D113 based on the ALU allocations conducted by the hardware allocation unit 1122. The RTL description conversion unit 1141 then outputs the generated RTL description D113 to the RTL description output unit 1113.

(Conversion Indicator Generation Unit 1142)

Based on hardware information described by the RTL descriptionD113, which has been generated in the RTL description conversion unit 1141, the conversion indicator generation unit 1142 calculates the area and the execution time of the hardware. Then, the conversion indicator generation unit 1142 stores, into the conversion result storage unit 1115, use information (a pair of the calculated area and execution time) in correspondence with the RTL description D113.

The conversion indicator generation unit 1142 generates the graph D114 with use of the pieces of use information (area and execution time) that are in one-two-one correspondence with the ALU allocation patterns (hereinafter, “actual allocation patterns”) described by the one or more RTL descriptions stored in the conversion result storage unit 1115. Then, the conversion indicator generation unit 1142 outputs the generated graph D114 to the graph notification unit 1114 as the program conversion indicator.

Note that the area and the execution time are calculated by the same calculation method described in the first embodiment, and the graph D114 is generated by the same method for the area/execution time prediction unit 1123 to generate the graph. Accordingly, explanations of these methods are omitted here.

(1.6) RTL Description Output Unit 1113

The RTL description output unit 1113 is an equivalent of the aforementioned object program output unit 1013.

Upon receiving the RTL description D113 from the RTL description conversion unit 1141, the RTL description output unit 1113 outputs the received RTL description D113 to a storage device (e.g., a hard disk unit).

An output destination of the RTL description D113 is not confined to the hard disk unit. The RTL description D113 may be outputted to any destination as long as the destination has an area for storing the RTL description D113.

(1.7) Graph Notification Unit 1114

The graph notification unit 1114 is an equivalent of the aforementioned program conversion indicator notification unit 1014.

Upon receiving the graph, which is the prediction result, from the area/execution time prediction unit 1123′, the graph notification unit 1114 notifies the user of the received graph.

Upon receiving the graph D114 from the conversion indicator generation unit 1142, the graph notification unit 1114 notifies the user of the received graph D114.

For example, the graph notification unit 1114 outputs the graph D114 to a display device (not illustrated) that is connected to the high-level synthesis apparatus 1100. The display device displays the graph D114. This way the graph notification unit 1114 can notify, by means of the display device, the user of the graph D114.

(2) Operations of High-Level Synthesis Apparatus 1100

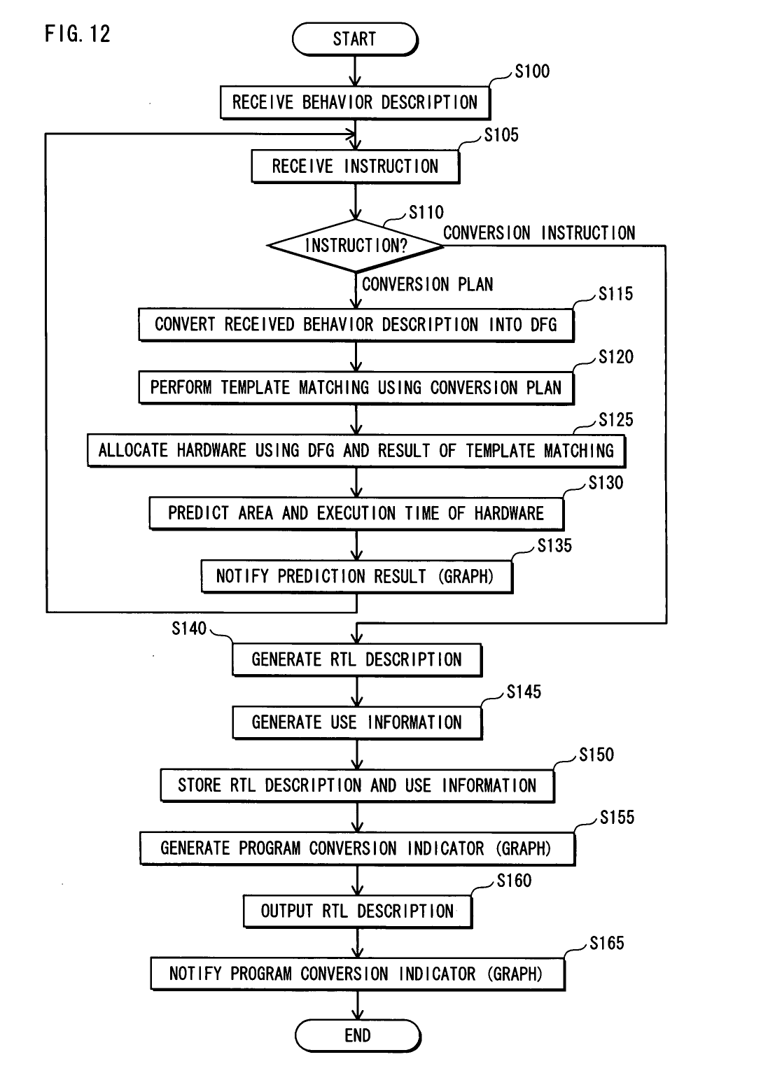

Referring to a flowchart shown in FIG. 12, the following describes operations of the high-level synthesis apparatus 1100.

The behavior description reception unit 1110 receives the behavior description D111 from the user (Step S100).

The reception unit 1111 receives the instruction (the conversion plan or the conversion instruction) from the user (Step S105).

The conversion prediction unit 1116 judges which one of the above two (the conversion plan and the conversion instruction) it has received (Step S110).

If the conversion prediction unit 1116 judges it has received the conversion plan (the “CONVERSION PLAN” branch of Step S110), the following operations are executed.

In the conversion prediction unit 1116, the DFG conversion unit 1120 converts the received behavior description D111 into the data flow graph (Step S115).

The template matching unit 1121 receives the conversion plan from the reception unit 1111 and the converted data flow graph from the DFG conversion unit 1120. Then, based on the received conversion plan D112, the template matching unit 1121 performs template matching (Step S120). Here, the template matching unit 1121 searches, in the converted data flow graph, a part that matches a part of the data flow graph D131 contained in the template D121 and that can thus be allocated with the hardware.

Based on a result of the search conducted by the template matching unit 1121, the hardware allocation unit 1122 allocates the hardware to the converted data flow graph (Step S125).

The area/execution time prediction unit 1123 predicts the area and the execution time of the hardware described by the object program (RTL description) corresponding to the behavior description D111, based on (i) the result of the ALU allocation conducted by the hardware allocation unit 1122 and (ii) the one or more RTL descriptions and the pieces of use information, which are in one-to-one correspondence with the one or more RTL descriptions, that are stored in the conversion result storage unit 1115 (Step S130). Here, the area/execution time prediction unit 1123 generates, as the prediction result of the program conversion indicator, the graph indicating the relationship between the execution time and the area of the hardware described by the object program (RTL description).

The graph notification unit 1114 notifies the user of the graph, which has been generated by the area/execution time prediction unit 1123, as the prediction result (Step S135).

On the other hand, if the conversion prediction unit 1116 judges it has received the conversion instruction (the “CONVERSION INSTRUCTION” branch of Step S110), the following operations are executed.

Based on the ALU allocation conducted by the hardware allocation unit 1122, the RTL description conversion unit 1141 generates the RTL description D113 (Step S140).

The conversion indicator generation unit 1142 generates the use information (the area and execution time of the hardware) (Step S145), and stores the RTL description D113 and the use information thereof into the conversion result storage unit 1115 (Step S150).

The conversion indicator generation unit 1142 generates the graph D114 based on the pieces of use information (area and execution time), which are in one-to-one correspondence with actual allocation patterns of the ALUs described by the one or more RTL descriptions stored in the conversion result storage unit 1115 (Step S155).

The RTL description output unit 1113 outputs the RTL description D113 generated by the RTL description conversion unit 1141 to the storage device (Step S160).

The graph notification unit 1114 notifies the user of the graph D114, which has been generated by the conversion indicator generation unit 1142, as the program conversion indicator by outputting the graph D114 to the display device (Step S165).

(3) Example of Prediction Operations

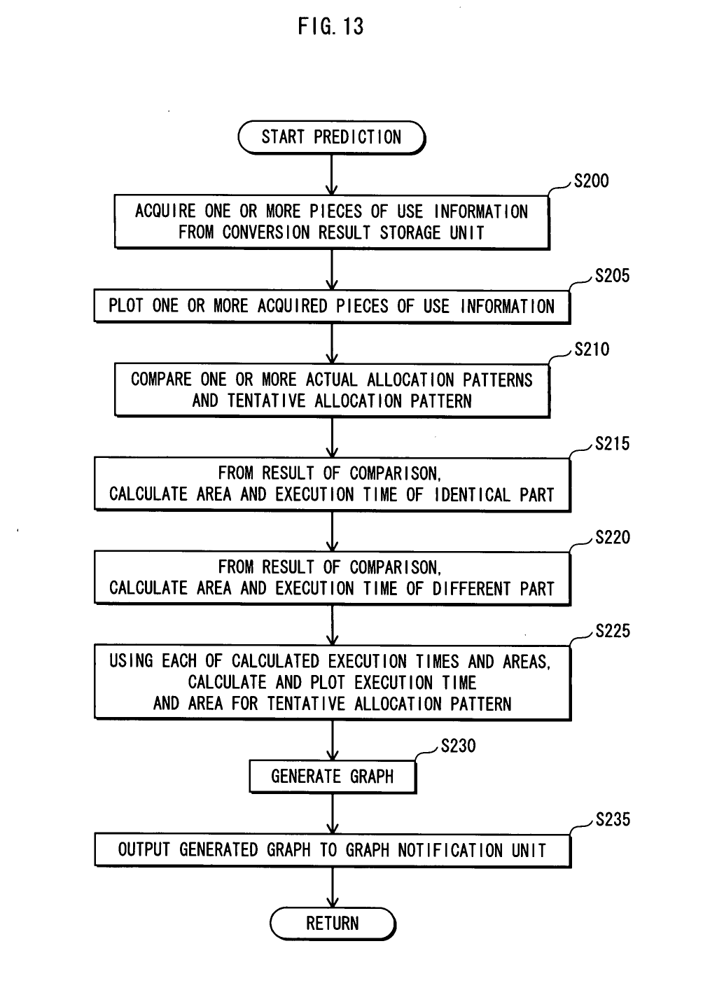

Referring to a flowchart shown in FIG. 13, the following describes an example of the prediction operations in Step S130 shown in FIG. 12.

The area/execution time prediction unit 1123 acquires the pieces of use information (area and execution time) each of which corresponds to a different one of allocation patterns (hereinafter, “actual allocation patterns”) of the ALUs described by the one or more RTL descriptions stored in the conversion result storage unit 1115 (Step S200).

The area/execution time prediction unit 1123 plots the acquired one or more pieces of use information on the two-dimensional plane (Step S205).

The area/execution time prediction unit 1123 compares (i) the one or more actual allocation patterns with (ii) the tentative allocation pattern generated by the hardware allocation unit 1122 (Step S210). After the comparison, with regard to a part of the tentative allocation pattern that is identical to a part of the actual allocation patterns, the area/execution time prediction unit 1123 calculates an area and an execution time of the identical part of the tentative allocation pattern with use of the actual allocation pattern (Step S215). With regard to a part of the tentative allocation pattern that is different from any part of the actual allocation pattern, the area/execution time prediction unit 1123 calculates an area and an execution time of the different part of the tentative allocation pattern with use of the tentative allocation pattern (Step S220). Then, the area/execution time prediction unit 1123 acquires a sum of each area and a sum of each execution time, and plots them on the two-dimensional plane (Step S225).

With use of the plotted coordinates and the least squares method, the area/execution time prediction unit 1123 generates a graph indicating the relationship between the area and execution time of the hardware that is described by the object program (RTL description) corresponding to the input program (Step S230).

The area/execution time prediction unit 1123 then outputs the generated graph to the graph notification unit 1114 (Step S235).

(4) Exemplary Operations of Generating Program Conversion Indicator

The following describes exemplary operations of generating the program conversion plan in Step S155 shown in FIG. 12. Here, the operations that are different from those shown in the flowchart of FIG. 13 are described.

The conversion indicator generation unit 1142 executes the operations of Steps S200 and S205 shown in FIG. 13.

Instead of executing the operations of Steps S210 through S225, the conversion indicator generation unit 1142 calculates an area and an execution time of an entire circuit to be generated based on the hardware information described by the RTL description D113 that has been generated by the RTL description conversion unit 1141. The conversion indicator generation unit 1142 then plots the calculated area and execution time.

The conversion indicator generation unit 1142 executes the operations of Steps S230 and S235.

(5) Summary of Specific Example

As set forth above, upon receiving the behavior description and the conversion plan, the high-level synthesis apparatus outputs (i) the RTL description and (ii) the graph indicating the relationship between the area and execution time of the hardware described by the RTL description.

There is a trade-off between the above two elements (area and execution time). An area/execution time graph visualizes these two elements in the form of a graph. This enables the user of the apparatus to readily acknowledge the relationship between the area and the execution time. With reference to this prediction result, the user of the apparatus develops an idea about a new template and template allocation pattern, and re-performs the high-level synthesis. This results in generation of an RTL description with superior quality.

### 3. Modification Examples

The foregoing has described the present invention based on, but not limited to, the above embodiments. The present invention includes the following cases.

(1) Although the high-synthesis apparatus notifies the user of the circuit diagram and the calculated value as the program conversion plan in the first embodiment, it is not limited to such a structure.

The high-synthesis apparatus may notify the user of either one of the circuit diagram and the calculated value. For example, if the high-synthesis apparatus notifies the user of only the circuit diagram, the user can judge whether or not the notified circuit diagram has the spec (area) he/she wants by calculating, from the notified circuit diagram, a sum of areas of the one or more allocated ALUs.

Furthermore, the user can judge whether or not the notified circuit diagram has specified the spec (execution time) he/she wants by calculating, from the notified circuit diagram, a sum of execution time of the one or more allocated ALUs.

Or, the high-level synthesis apparatus described in the first embodiment may notify the user of a graph indicating a relationship between the area and the execution time, just like as described in the specific example section of the second embodiment.

(2) In the second embodiment, the high-level synthesis apparatus may notify the user of the circuit diagram and the calculated value instead of the graph.

(3) In the first embodiment, the high-level synthesis apparatus may, before generating the RTL description, predict the program conversion indicator (circuit diagram and calculated value) that corresponds to the hardware described by the RTL description to be generated, and notify the user of the prediction result, just like as described in the second embodiment.

(4) In the first embodiment, the program conversion plan (hardware allocation information) is the information for minimizing the execution time of the hardware, or the information for minimizing the area of the hardware. However, the program conversion plan is not limited to these.

The program conversion plan (hardware allocation information) may be information for minimizing a code size of the object program. In this case, for example, the program conversion apparatus generates the code size of the object program in the conversion indicator generation unit, and notifies, by way of the notification unit, the user of the generated code size as the program conversion indicator.

Or, the program conversion plan (hardware allocation information) may be information for minimizing power consumed by the hardware (object program) while the hardware is being executed. In this case, for example, the program conversion apparatus measures, in the conversion indicator generation unit, the power consumption of the object program with use of a tool for measuring power consumption. The program conversion apparatus then notifies, by way of the notification unit, the user of a result of the measurement as the program conversion indicator.

Or, the program conversion apparatus may regard each of the aforementioned code size, power consumption, area of the hardware and execution time of the hardware as a parameter, and receive one or more parameters as the program conversion plan. In this case, the program conversion apparatus converts the input program into the object program in such a manner that, among calculated values of respective parameters, at least one has the smallest number. The program conversion apparatus then notifies the user of a combination of the calculated values (the calculated values each of which corresponds to a different one of the one or more received parameters) as the program conversion indicator by way of the notification unit. For example, upon receiving two parameters (the area and execution time of the hardware), the program conversion apparatus notifies the user of the area and execution time of the hardware.

Or, the program conversion apparatus may receive, as the program conversion plan, (i) one or more parameters (the same types of parameters as described earlier) together with (ii) predetermined values that are in one-to-one correspondence with the one or more parameters. In this case, the program conversion apparatus converts the input program into the object program in such a manner that, among the calculated values of respective parameters, at least one is less than or equals to the corresponding predetermined value. The program conversion apparatus then notifies the user of the combination of the calculated values as the program conversion indicator by way of the notification unit. For example, upon receiving a parameter and a predetermined value corresponding thereto, the program conversion apparatus converts the input program into the object program in such a manner that the calculated value of the received parameter is less than or equals to the predetermined value corresponding thereto. The program conversion apparatus then notifies, by way of the notification unit, the user of the program conversion indicator composed of the calculated value of the one received parameter.

In the specific example section of the first embodiment, the hardware allocation information is inputted as the program conversion plan. Here, even if other conversion plans are specified (e.g., the information for minimizing the execution time, and the information for minimizing the code size), the hardware allocation is performed based on these plans, just like when the hardware allocation information is inputted as the program conversion plan.

(5) In the second embodiment, it is permissible for the program conversion plan (the hardware allocation information) to be information for minimizing the code size of the object program. In this case, the program conversion apparatus predicts, in the input program conversion prediction unit, the code size of the object program based on the received program conversion plan. The program conversion apparatus then notifies a result of the prediction to the user. If receiving the conversion instruction, the program conversion apparatus performs the same operations as the program conversion apparatus described in the above (4). Here, the program conversion apparatus predicts the code size based on a code size of an object program that was generated in the past. For example, the program conversion apparatus has prestored (i) one or more input programs that were input in the past (old input programs), (ii) object programs (old object program) each of which corresponds to a different one of the old input programs, and (iii) respective code sizes of the old object programs. The program conversion apparatus compares the latest input program that has just been input with the old input programs, and searches, in the latest input program, a part that is identical to a part of the old input programs. The program conversion apparatus acquires a code size of this identical part from the part of the old input programs and its corresponding code size. In contrast, the program conversion apparatus acquires a code size of a part of the latest input program that is other than the identical part by conducting the program conversion. The program conversion apparatus regards a sum of the acquired code sizes as the prediction result.

It is also permissible for the program conversion plan (hardware allocation information) to be the information for minimizing the power consumed by the hardware (object program) while the hardware is being executed. I-n this case, the program conversion apparatus predicts, in the input program conversion prediction unit, the code size of the object program based on the received program conversion plan, and then notifies the user of a result of the prediction. If receiving the conversion instruction, the program conversion apparatus performs the same operations as the program conversion apparatus described in the above (4). Here, the program conversion apparatus predicts the power consumption with reference to power consumption of the old object programs that have been generated in the past. For example, the program conversion has prestored (i) one or more old object programs that have been converted in the past and (ii) respective power consumptions of the old object programs. First, the program conversion apparatus allocates hardware to the latest input program that has just been input. Then, by comparing this hardware allocation made to the latest input program with a hardware allocation described by the one or more old object programs, the program conversion apparatus searches, in the latest input program, a part that is identical to a part of the old object programs. The program conversion apparatus acquires power consumption of this identical part from the part of the old object programs and its corresponding power consumption. In contrast, the program conversion apparatus acquires power consumption of a part of the latest input program that is other than the identical part from a result of the hardware allocation made thereto. The program conversion apparatus regards a sum of the acquired power consumptions as the prediction result.

It is also permissible for the program conversion apparatus to regard each of the aforementioned code size, power consumption, area of the hardware and execution time of the hardware as a parameter, and receive one or more parameters as the program conversion plan. In this case, the program conversion apparatus predicts, in the input program conversion prediction unit, the program conversion indicator based on the received program conversion plan, and then notifies the user of the prediction result. If receiving the conversion instruction, the program conversion apparatus performs the same operations as the program conversion apparatus described in the above (4).

It is also permissible for the program conversion apparatus to receive, as the program conversion plan, one or more parameters (the same types of parameters as described earlier) together with predetermined values, each of which corresponds to a different one of the parameters. In this case, the program conversion apparatus predicts, in the input program conversion prediction unit, the program conversion indicator based on the received program conversion plan, and then notifies the user of the prediction result. If receiving the conversion instruction, the program conversion apparatus performs the same operations as the program conversion apparatus described in the above (4).

(6) In the first embodiment, entire contents described in the input program (behavior description) are converted into the object program (RTL description). However, the conversion may be done in different manners.

The program conversion apparatus may convert only a part of the input program into the object program. In this case, the program conversion apparatus receives (i) the input program and (ii) as the program conversion plan, information indicating a part of the input program to be converted. As indicated by the received program conversion plan, the program conversion apparatus converts only the part of the input program to be converted into the object program, and generates a program conversion indicator for the post-conversion object program. Then the program conversion apparatus notifies the user of the generated program conversion indicator.

Similarly, in the second embodiment, the program conversion apparatus may convert only a part of the input program into the object program. In this case, the program conversion apparatus receives (i) the input program and (ii) as the program conversion plan, the information indicating the part of the input program to be converted. The program conversion apparatus predicts, in the input program conversion prediction unit, a program conversion indicator for a part of the object program that corresponds to the part of the input program to be converted as shown by the received program conversion plan. The program conversion apparatus then notifies the user of the prediction result. If receiving the conversion instruction, the program conversion apparatus only converts the part of the input program to be converted, which is shown by the received program conversion plan, into the object program, and generates a program conversion indicator for the post-conversion object program. Then, the program conversion apparatus notifies the user of the generated program conversion indicator.

(7) In the first embodiment, the program conversion apparatus receives, but not limited to, the input program and the program conversion plan.

It is permissible for the program conversion apparatus to receive only the input program. In this case, the program conversion apparatus converts the received input program into the object program, and generates a program conversion indicator for the post-conversion object program. The program conversion apparatus then notifies the user of the generated program conversion indicator. With reference to the notified program conversion indicator, the user judges whether or not the circuit described by the object program has the spec he/she wants. If judging the circuit does not have the spec, the user makes improvements in the input program. The program conversion apparatus receives the improved input program and performs the same operations as described above.

Similarly, in the second embodiment, it is permissible for the program conversion apparatus to receive only the input program. In this case, the program conversion apparatus predicts a program conversion indicator for the object program corresponding to the received input program, and notifies the user of the prediction result. With reference to the notified prediction result, the user judges whether or not the circuit described by the object program has the spec he/she wants. If judging the circuit does not have the spec, the user makes improvements in the input program. The program conversion apparatus receives the improved input program, re-predicts a program conversion indicator, and notifies the user of a result of the re-prediction. If the user judges the notified result of the re-prediction reflects the spec he/she wants, the user issues the conversion instruction to the program conversion apparatus. Upon receiving the conversion instruction, the program conversion apparatus converts the input program into the object program, and generates a program conversion indicator for the post-conversion object program.

(8) In the first embodiment, it is permissible to configure the program conversion apparatus as follows. When converting an input program that has never been converted before into an object program, the program conversion apparatus receives this input program only. On the other hand, when re-converting an input program, which has been converted before, into an object program, the program conversion apparatus receives a program conversion plan.

In the above case, the program conversion apparatus first receives only the input program, converts the received input program into the object program, and then generates a program conversion indicator (e.g., area) for the post-conversion object program. After that, the program conversion apparatus notifies the user of the generated program conversion indicator. With reference to the notified program conversion indicator, the user judges whether or not the circuit described by the object program has the spec he/she wants. If judging the circuit does not have the spec, the user inputs the program conversion plan and the input program to the program conversion apparatus. Based on the program conversion plan, the program conversion apparatus converts the input program into the object program, and generates a program conversion indicator for the post-conversion object program. The program conversion apparatus then notifies the user of the generated program conversion indicator.

Here, the generated program conversion indicator may be (i) the execution time, (ii) the power consumption, (iii) the code size, and (iv) the graph indicating the relationship between the area and the execution time.

Also, in the second embodiment, it is permissible to configure the program conversion apparatus as follows. When converting an input program, which has never been converted before, into an object program, the program conversion apparatus receives only this input program. On the other hand, when re-converting an input program that has been converted before into an object program, the program conversion apparatus receives a program conversion plan.

In the above case, the program conversion apparatus first receives only the input program, predicts a program conversion indicator (e.g., a graph indicating the relationship between the area and execution time of the hardware) for the object program corresponding to the input program, and then notifies the user of a result of the prediction. With reference to the notified prediction result, the user judges whether or not the prediction result shows the spec he/she wants. If judging the prediction result does now show the spec, the user inputs the program conversion plan and the input program to the program conversion apparatus. Based on the program conversion plan, the program conversion apparatus re-predicts a program conversion indicator and notifies the user of a result of the re-prediction. If the user judges the notified result of the re-prediction shows the spec he/she wants, the user issues the conversion instruction to the program conversion apparatus. Upon receiving the conversion instruction, the program conversion apparatus converts the input program into the object program, and generates a program conversion indicator for the post-conversion object program.

Here, the generated program conversion indicator may be the area, execution time, power consumption and code size of the hardware.

(9) In the first embodiment, the information that the program conversion apparatus notifies to the user may be detailed information regarding the conversion of the input program, such as a scheduling method, and when the object program is the hardware technology information, a method for allocating the ALU.

(10) In the second embodiment, the conversion result storage unit of the high-level synthesis apparatus stores, but not limited to, the one or more object programs (RTL descriptions) that have been converted in the past and the pieces of use information that are in one-to-one correspondence with the one or more object programs.

It is permissible for the conversion result storage unit to store one or more allocation patterns that have been input in the past (old allocation patterns), and pieces of use information each of which corresponds to a different one of the old allocation patterns.

In this case, with regard to an allocation pattern of the input program that is identical to one of the old allocation patterns, the area/execution time prediction unit plots, on the two-dimensional plane, use information (area and execution time) that corresponds to the one of the old allocation patterns. On the other hand, with regard to an allocation pattern of the input program that is not identical to any of the old allocation patterns, the area/execution time prediction unit calculates an area and an execution time corresponding to this non identical part, and plots the calculated area and execution time on the two-dimensional plane. Then the area/execution time prediction unit generates a graph.

It is also permissible for the conversion result storage unit to store one or more pairs of (i) an old allocation pattern that was inputted in the past and (ii) an object program that originates from the inputted old allocation pattern.

In this case, the area/execution time prediction unit compares a current ALU allocation pattern with ALU allocation patterns from the past (old ALU allocation patterns). With regard to a part of the current ALU allocation pattern that is nonidentical to any part of the old ALU allocation patterns, the area/execution time prediction unit re-allocates hardware to the nonidentical part. On the other hand, with regard to a part of the current ALU allocation pattern that is identical to apart of the old ALU allocation patterns, the area/execution time prediction unit applies the part of the old ALU allocation patterns to the identical part of the current ALU allocation pattern. This way the area/execution time prediction unit conducts the ALU allocation in an easy manner, and regards the execution time and the area as the prediction result.

(11) The first embodiment has described, as one example of the program conversion indicator, the conversion indicator composed of the circuit diagram and the calculated value. However, the program conversion indicator is not limited to such.

The program conversion indicator may be any one of, or any combination of the (i) area, (ii) execution time and (iii) power consumption of the entire circuit described by the object program.

Similarly, in the second embodiment, the program conversion indicator may be any one of, or any combination of the (i) area, (ii) execution time, (iii) power consumption, (iv) code size, and (v) a graph indicating the relationship between the area and the execution time of the entire circuit described by the object program.

(12) In the second embodiment, the area/execution time prediction unit conducts the following in generating the graph: the area/execution time prediction unit first plots, on the two-dimensional plane, (i) the pieces of use information (area and execution time) each of which corresponds to the respective one of the actual allocation patterns and (ii) the area and the execution time corresponding to the tentative allocation pattern. The area/execution time prediction unit then generates the graph by the application of the least squares method. However, the graph may be generated in different manners.

The area/execution time prediction unit may first plot, on the two-dimensional plane, the pieces of use information (area and execution time) each of which corresponds to the respective one of the actual allocation patterns, and then generate the graph by the application of the least squares method. After that, the area/execution time prediction unit may plot the area and the execution'time corresponding to the tentative allocation pattern as a predicted value.

(13) In the first embodiment, if the calculated value is the execution time of the circuit described by the RTL description, the spec of the circuit in the present invention represents the execution time of the circuit.

If the calculated value is the power consumption of the circuit, the spec of the circuit in the present invention represents the power consumption of the circuit.

If the calculated value is the code size, the spec of the circuit in the present invention represents the code size of the RTL description that expresses a design of the circuit.

If the circuit diagram is notified as the conversion indicator, the spec of the circuit in the present invention represents the circuit diagram showing the circuit.

In the second embodiment, the spec of the circuit in the present invention may be the area or the execution time of the circuit.

(14) In the second embodiment, the program conversion result storage unit and the input program conversion prediction unit are each constructed as an individual unit. However, these units may be constructed in different manners.

The program conversion result storage unit may be included in the input program conversion prediction unit.

(15) In the first embodiment, the high-level synthesis apparatus has been described as an example of the program conversion apparatus. However, the program conversion apparatus may be in a different form.

The program conversion apparatus may be a compiler apparatus. In this case, the compiler apparatus receives an input program written in a high-level language together with a program conversion plan. Based on the received program conversion plan, the compiler apparatus converts the input program into a machine language (e.g., an assembly language) as an object program, outputs the post-conversion language, generates a program conversion indicator for the post-conversion language, and notifies a user of the generated program conversion indicator. For example, if the program conversion plan is information for minimizing a code size of the object program, the program conversion indicator is the code size of the object program.

(16) The present invention may be methods shown by the above. Furthermore, the methods may be a computer program realized by a computer, and may be a digital signal of the computer program.

Furthermore, the present invention may be a computer-readable recording medium apparatus such as a flexible disk, a hard disk, a CD-ROM (compact disc-read only memory), and MO (magneto-optical), a DVD, a DVD-ROM (digital versatile disc-read only memory), a DVD-RAM, a BD (Blu-ray Disc) or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(17) The present invention may be any combination of the above-described embodiments and modifications.

### 4. Conclusion

In the first embodiment, the program conversion apparatus notifies the user of the program conversion indicator. With reference to the notified program conversion indicator, the user can easily develop a more efficient program conversion plan. The user repeats the following steps until he/she can acquire the object program that describes the circuit having the spec he/she wants: (i) the user inputs the input program and the program conversion plan to the program conversion apparatus, (ii) the user is notified of the program conversion indicator by the program conversion apparatus, and (iii) develop a more efficient conversion plan based on the notified program conversion indicator.

In the second embodiment, the program conversion apparatus predicts the program conversion indicator and notifies the user of the prediction result (e.g., the graph) before generating the object program (e.g., the RTL description) from the input program (e.g. the behavior description). After that, upon receiving the conversion instruction from the user, the program conversion apparatus notifies the user of the program conversion indicator (e.g., the graph) after converting the input program into the object program.

The following describes differences between (i) content of the prediction result and (ii) content of the conversion result after the program conversion is actually executed. When the program conversion apparatus predicts the conversion result, the input program is not actually converted to the object program. This reduces the time required to convert the input program. Accordingly, the prediction result can be notified to the user briefly after the input of the input program and the program conversion plan. However, since it is only a prediction, there is a case where the prediction result differs from the indicator that is notified after the input program is actually converted. In contrast, when notifying the user of the actual conversion result, the program conversion apparatus actually converts the input program into the object program. Therefore, the time period from the input of the input program and the program conversion plan to the notification of the program conversion indicator is longer than the case of predicting the conversion result. However, the content of the conversion result after the program conversion is actually executed is reliable, because the program conversion indicator is generated based on the actual conversion.

The program conversion apparatus of the present invention notifies the user of the conversion indicator for the object program that has been actually converted. This allows the user to easily develop a better program conversion plan by referencing the conversion indicator. If the user inputs the better conversion plan to the program conversion apparatus, the apparatus can generate a better object program. The repetition of the above gradually improves the spec (quality) of the circuit described by the object program, and ultimately provides an object program that has the spec the user wants.

The program conversion apparatus of the present invention is a program conversion apparatus for converting an input program into an object program, comprising: a program input unit operable to receive the input program; a conversion unit operable to convert the input program into the object program; an object program output unit operable to output the object program, which is a result of the conversion; and a conversion indicator notification unit operable to notify a user of the apparatus of a conversion indicator for the input program, the conversion indicator being generated by a process for converting the input program. This program conversion apparatus enables the user to acquire, from the apparatus, information other than the object program.

The program conversion apparatus notifies the user of an execution time of the object program as the conversion indicator. Since this apparatus enables the user to acknowledge the execution time of the object program when the object program is being converted, the user can, with reference to the execution time, easily develop a more efficient program conversion plan.

The program conversion apparatus also notifies the user of, as the conversion indicator, a correlative relationship between the execution time of the object program and an area of hardware that is achieved by the object program. This apparatus enables the user to acknowledge the correlative relationship between the execution time of the object program and the area of the hardware achieved by the post-conversion object program. Based on the correlative relationship, the user can easily develop a more efficient program conversion plan.

The program conversion apparatus also notifies the user of, as the conversion indicator, a code size of the object program. This apparatus enables the user to acknowledge the codes size of the post-conversion object program. Based on the code size, the user can easily develop a more efficient program conversion plan.

The program conversion apparatus also notifies the user of, as the conversion indicator, the area of the hardware achieved by the object program. This apparatus enables the user to acknowledge the area of the hardware achieved by the object program. Based on the area, the user can easily develop a more efficient program conversion plan.

The program conversion apparatus also notifies the user of, as the conversion indicator, power consumed to execute the object program. This apparatus enables the user to acknowledge such a power consumption; based on which, the user can easily develop a more efficient program conversion plan.

The program conversion apparatus further includes a conversion plan input unit operable to receive a conversion plan that is a request from the user regarding the conversion of the input program, wherein the aforementioned conversion unit converts the input program based on the conversion plan. The program conversion apparatus outputs the object program with high quality when such an efficient conversion plan is input thereto, compared to when the conversion plan is not input thereto.

The conversion plan that is input to the program conversion apparatus is generated by the user based on the aforementioned conversion indicator. The user can acquire the object program with high quality when inputting such an efficient conversion plan into the program conversion apparatus, compared to when not inputting the conversion plan into the same.

The program conversion apparatus receives, as the conversion plan, information for specifying, in the input program, a part to be converted. When re-receiving the program conversion plan and thus when re-converting the input program, the program conversion apparatus does not convert a part of the object program that has already satisfied the requirement of the user. Accordingly, the program conversion apparatus can reduce the time required for the program conversion.

The program conversion apparatus also receives, as the conversion plan, an instruction to convert the input program so as to minimize the execution time of the object program. Through the program conversion, this apparatus provides the object program that has a minimal execution time.

The program conversion apparatus also receives, as the conversion plan, an instruction to convert the input program so as to minimize the area of the hardware achieved by the object program. Through the program conversion, this apparatus provides the object program that achieves hardware having a minimal area.

The program conversion apparatus also receives, as the conversion plan, an instruction to convert the input program such that the object program achieves the lowest power consumption. Through the program conversion, this apparatus provides the object program that achieves the lowest power consumption.

The program conversion apparatus also receives, as the conversion plan, an instruction to convert the input program so as to minimize the code size of the object program. Through the program conversion, this apparatus provides the object program having a minimal code size.

The program conversion apparatus also receives, as the conversion plan, an instruction to convert the input program so as to set one or more parameters of the object program to or below respective predetermined values. This apparatus enables the user to acquire the object program having one or more parameters that are set to or below respective predetermined values.

The program conversion apparatus also receives, as the conversion plan, an instruction to convert the input program so as to set the execution time of the object program to or below a predetermined value. This apparatus enables the user to acquire the object program whose execution time is set to or below the predetermined devalue.

The program conversion apparatus also receives, as the conversion plan, an instruction to convert the input program so as to set the area of the hardware achieved by the object program to or below a predetermined value. This apparatus enables the user to acquire the object program that achieves hardware whose area is set to or below the predetermined value.

The program conversion apparatus also receives, as the conversion plan, an instruction to convert the input program so as to set the power consumption of the hardware achieved by the object program to or below a predetermined value. This apparatus enables the user to acquire the object program that achieves hardware whose power consumption is set to or below the predetermined value.

The program conversion apparatus also receives, as the conversion plan, an instruction to convert the input program so as to set the code size of the object program to or below a predetermined value. This apparatus enables the user to acquire the object program whose code size is set to or below the predetermined value.

The program conversion apparatus also receives, as the conversion plan, information regarding an ALU allocation pattern, which is defined as a correlative relationship between an operation of the object program and hardware achieved by the object program. Through the program conversion, the program conversion apparatus enables the user to acquire the object program that complies with the aforementioned ALU allocation pattern that has been input thereto.

The program conversion apparatus further includes a template, which is defined as information showing a pair of (i) a circuit diagram of the aforementioned hardware and (ii) an operation of the circuit diagram. According to this apparatus, the circuit diagram of the hardware described by the object program includes a circuit of the template. This way, the user can design a part of the circuit diagram that is to be output.

The program conversion apparatus further includes a prediction unit operable to (i) predict the conversion result of the input program or the conversion indicator and (ii) input the predicted conversion result or conversion indicator to the aforementioned conversion indicator notification unit, wherein the conversion indicator notification unit further notifies the user of the object program, which is the predicted conversion result, or the predicted conversion indicator. This apparatus enables the user to redevelop the program conversion plan or the program conversion indicator based on the conversion prediction result instead of a result of the actual program conversion. Therefore, the apparatus can reduce the time required for the program conversion.

The program conversion apparatus further includes a storage unit operable to store therein the object program (the conversion result of the input program) and the conversion plan that have been generated in the past, wherein the program conversion apparatus predicts, based on items stored in the storage unit, the conversion result of the input program. That is, with use of information stored in the storage unit, this apparatus can predict the program conversion result.

The program conversion apparatus finds a difference between a conversion plan that has been input in the past and the current conversion plan that has just been input (these conversion plans are both stored in the storage unit). Based on the difference and the program conversion result from the past, the program conversion apparatus further predicts the conversion result of the current input program. This apparatus enables the user to acquire a prediction result based on the difference between the conversion plan from the past and the current conversion plan.

The program conversion apparatus also predicts the area of the hardware achieved by the object program or the execution time of the object program. This apparatus enables the user to acknowledge, before the input program is actually converted, a program conversion result and a corresponding program conversion indicator showing that the area of the hardware is large or the execution time of the object program is long. When re-developing the program conversion plan, the user can therefore acknowledge, without the actual conversion of the input program, a program conversion indicator in the case where the area of the hardware is large, or the execution time of the object program is long. This reduces the time required for the program conversion in the case where the area of the hardware is large or the execution time of the object program is long.

The program conversion apparatus also predicts the code size of the object program. This apparatus enables the user to acknowledge, before the input program is actually converted, a program conversion result and a corresponding program conversion indicator showing that the code size of the object program is large. When re-developing the program conversion plan, the user can therefore acknowledge, without the actual conversion of the input program, a program conversion indicator in the case where the code size of the object program is large. This reduces the time required for the program conversion in the case where the code size of the object program is large.

The program conversion apparatus also predicts the circuit diagram of the hardware achieved by the object program. This apparatus enables the user to acknowledge, before the input program is actually converted, a program conversion result and a corresponding program conversion indicator showing that the circuit diagram of the hardware is large. When re-developing the program conversion plan, the user can therefore acknowledge, without the actual conversion of the input program, a program conversion indicator in the case where the circuit diagram of the hardware is large. This reduces the time required for the program conversion in the case where the circuit diagram of the hardware is large.

The program conversion apparatus also predicts the conversion result of the current input program based on (i) the current ALU allocation pattern that is input from the conversion plan input unit, (ii) an old ALU allocation pattern from the past that is stored in the storage unit, and (iii) the conversion result of the old input program that has been input in the past. This apparatus enables the user to acquire a prediction result based on the above (i), (ii) and (iii).

When predicting the conversion result of the current input program based on a difference between the old ALU allocation pattern and the current ALU allocation pattern, the program conversion apparatus executes the following. With regard to a part of the current ALU allocation pattern that is identical to apart of the old ALU allocation pattern, the program conversion apparatus uses the conversion result of the old input program (derived from the old ALU allocation pattern) as that of the current input program. On the other hand, with regard to a part of the current ALU allocation pattern that is not identical to any part of the old ALU allocation pattern, the program conversion apparatus regards a result of the conversion of the current input program as the conversion prediction result. This apparatus enables the user to acquire the conversion prediction result in the case where the ALU is newly allocated only to the part of the current ALU allocation pattern that is not identical to any part of the old ALU allocation pattern.

### 6. Industrial Applicability

The present invention can be utilized business-wise (i.e., recurrently and continuously) in an industry that manufactures and sells a program conversion apparatus.

The program conversion apparatus of the present invention can be utilized business-wise (i.e., recurrently and continuously) by manufactures who design system LSIs by using the program conversion apparatus.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A program conversion apparatus for converting a type of program into another type of program based on a description of the type of program, the program conversion apparatus comprising:
a conversion unit operable to convert an operation description program, in which a sequence of operations are described, into a circuit description program in which a design of a circuit that realizes the sequence of operations is described;
a program output unit operable to output the circuit description program;
a generation unit operable to generate an indicator that shows a spec of the circuit that is realized by using one or more hardware elements in accordance with the design described in the circuit description program; and
an indicator output unit operable to output the generated indicator.

2. The program conversion apparatus of claim 1, further comprising:
a plan reception unit operable to receive, before the conversion unit performs the conversion, a plan showing a spec that a user wants for the circuit that realizes the sequence of operations, wherein
the conversion unit converts the operation description program into the circuit description program based on the plan.

3. The program conversion apparatus of claim 2, wherein
the generation unit generates the indicator that includes the spec shown by the received plan.

4. The program conversion apparatus of claim 2, wherein
the spec the user wants is allocation of a hardware element that has been specified by the user,
the plan reception unit receives as the plan, a template that contains, in correspondence, (i) a circuit diagram of the hardware element that has been specified by the user and (ii) operation information that shows a processing operation of the hardware element that has been specified by the user, and
if the operation description program has a first part that conducts the processing operation shown by the operation information contained in the received template, the conversion unit generates the circuit description program whose design allocates, to the first part, the hardware element shown by the circuit diagram corresponding to the operation information.

5. The program conversion apparatus of claim 4, wherein
the plan reception unit further receives an allocation pattern that specifies, in the operation description program, an allocatable part that can be allocated with the hardware element shown by the circuit diagram contained in the template, and
the conversion unit generates the circuit description program whose design allocates the hardware element, which is shown by the circuit diagram corresponding to the operation information, only to the first part that is also specified by the allocation pattern as the allocatable part, and not to the first part that is not specified by the allocation pattern as the allocatable part.

6. The program conversion apparatus of claim 1, wherein
before the conversion unit performs the conversion, the generation unit predicts (i) the design and (ii) the indicator that shows the spec of the circuit that is realized in accordance with the predicted design, and
before the conversion unit performs the conversion, the indicator output unit outputs the predicted indicator.

7. The program conversion apparatus of claim 6, wherein
the generation unit has prestored therein prediction information that is used for performing the prediction, and predicts the indicator based on the prediction information and the predicted design.

8. The program conversion apparatus of claim 7, wherein
the prediction information is composed of (i) a generated program, which is a circuit description program that has been generated in the past and (ii) a generated indicator, which shows a spec of a circuit that is realized in accordance with a design described in the generated program, and
the generation unit searches, in the operation description program, a second part that conducts a same processing operation as a part of the generated program, and predicts the indicator by allocating (i) to the second part, a generated partial indicator that is based on the generated indicator, and (ii) to a part of the operation description program other than the second part, a predicted partial indicator that has been predicted.

9. The program conversion apparatus of claim 8, further comprising:
a template reception unit operable to receive a template that contains, in correspondence, (i) a circuit diagram of a hardware element that has been specified by a user and (ii) operation information that shows a processing operation of the hardware element that has been specified by the user, wherein
if the operation description program has a first part that conducts the processing operation showy by the operation information contained in the received template, the conversion unit predicts the design by allocating, to the first part, the hardware element shown by the circuit diagram corresponding to the operation information.

10. The program conversion apparatus of claim 9, wherein
the template reception unit further receives an allocation pattern that specifies, in the operation description program, an allocatable part that can be allocated with the hardware element shown by the circuit diagram that is contained in the template, and
if the operation description program has a first part that conducts the processing operation shown by the operation information contained in the received template, the generation unit predicts the design by allocating the hardware element, which is shown by the circuit diagram corresponding to the operation information, only to the first part that is also specified by the allocation pattern as the allocatable part, and not to the first part that is not specified by the allocation pattern as the allocatable part.

11. The program conversion apparatus of claim 1, wherein
the spec of the circuit is an area of the circuit,
the indicator is an area indicator showing the area of the circuit that is realized in accordance with the design described in the circuit description program, and
the generation unit (i) acquires respective areas of the one or more hardware elements to be allocated in realizing the circuit, (ii) calculates a sum of the acquired areas, and (iii) regards the calculated sum as the area indicator.

12. The program conversion apparatus of claim 1, wherein
the spec of the circuit is an execution time of the circuit,
the indicator is an execution time indicator showing the execution time of the circuit that is realized in accordance with the design described in the circuit description program, and
the generation unit (i) based on the design, determines execution cycles to each of which a different one of the one or more hardware elements to be allocated belongs, (ii) based on the determination, acquires a number of the execution cycles and a unit of time per execution cycle, (iii) calculates the execution time of the circuit using the acquired number of the execution cycle and the acquired unit of time, and (iv) regards the calculated execution time as the execution time indicator.

13. The program conversion apparatus of claim 1, wherein
the spec of the circuit is a power consumption of the circuit,
the indicator is a power consumption indicator showing the power consumption of the circuit that is realized in accordance with the design described in the circuit description program, and
the generation unit (i) calculates the power consumption of the circuit based on a connection condition between the one or more hardware elements shown by the design and (ii) regards the calculated power consumption as the power consumption indicator.

14. The program conversion apparatus of claim 1, wherein
the spec of the circuit is a code size of the circuit description program, and
the generation unit (i) calculates the code size of the circuit description program and (ii) regards the calculated code size as the indicator.

15. The program conversion apparatus of claim 1, wherein
the spec of the circuit is correlation information showing a correlation between an area and an execution time of the circuit,
the indicator is a relation information indicator showing the correlation in the circuit that is realized in accordance with the design described in the circuit description program, and
the generation unit (i) calculates the area and the execution time of the circuit that is realized in accordance with the design, (ii) acquires the correlation information based on the calculated area and execution time of the circuit, and (iii) regards the acquired correlation information as the relation information indicator.

16. The program conversion apparatus of claim 1, wherein
the spec of the circuit is a circuit diagram,
the indicator is a circuit diagram of the circuit that is realized in accordance with the design described in the circuit description program, and
the generation unit generates the circuit diagram of the circuit based on a connection condition between the one or more hardware elements shown by the design, and regards the generated circuit diagram as the indicator.

17. The program conversion apparatus of claim 1, wherein
the spec of the circuit is a combined spec that contains at least two of the following: (i) an area of the circuit; (ii) an execution time of the circuit; (iii) correlation information showing a correlation between the area and the execution time of the circuit; (iv) a circuit diagram; and (v) a code size of the circuit description program,
the indicator is a combined indicator showing the combined spec of the circuit that is realized in accordance with the design described in the circuit description program,
the generation unit generates the combined indicator, and
the indicator output unit outputs the generated combined indicator.

18. A program conversion method used in a program conversion apparatus that converts a type of program into another type of program based on a description of the type of program, the program conversion method comprising the steps of:
converting an operation description program, in which a sequence of operations are described, into a circuit description program, in which a design of a circuit that realizes the sequence of operations is described;
outputting the circuit description program;
generating an indicator that shows a spec of the circuit that is realized by using one or more hardware elements in accordance with the design described in the circuit description program; and
outputting the generated indicator.

19. A computer program used in a program conversion apparatus that converts a type of program into another type of program based on a description of the type of program, the computer program comprising the steps of:
converting an operation description program, in which a sequence of operations are described, into a circuit description program, in which a design of a circuit that realizes the sequence of operations is described;
outputting the circuit description program;
generating an indicator that shows a spec of the circuit that is realized by using one or more hardware elements in accordance with the design described in the circuit description program; and
outputting the generated indicator.

20. The computer program of claim 19, wherein
the computer program is stored in a computer-readable storage medium.
